(19) United States
(12) Patent Application Publication
(10) Pub. No.: US 2016/0137904 A1
(43) Pub. Date: May 19, 2016

(54) PROPPANTS AND METHODS OF USE THEREOF

(71) Applicant: Preferred Technology, LLC, Radnor, PA (US)

(72) Inventors: Kerry Drake, Radnor, PA (US); Robert R. McDaniel, Radnor, PA (US); Spyridon Monastiriotis, Radnor, PA (US); Amr M. Radwan, Radnor, PA (US); Ralph E. Barthel, Radnor, PA (US)

(21) Appl. No.: 14/928,379

(22) Filed: Oct. 30, 2015

Related U.S. Application Data
(60) Provisional application No. 62/072,479, filed on Oct. 30, 2014.
(60) Provisional application No. 62/134,058, filed on Mar. 17, 2015.

(51) Int. Cl. C09K 8/536; C09K 8/60; C09K 8/80

(52) U.S. Cl. CPC C09K 8/536; C09K 8/805; C09K 8/605

(57) ABSTRACT

Proppants for use in fractured or gravel packed/frac packed oil and gas wells are provided with a treatment agent component that provides the proppant with one or more additional chemical, functions, and/or mechanical functions that can be used, for example, in oil and gas well production.

### CROSS-REFERENCE TO RELATED APPLICATIONS

This application claims priority to U.S. Provisional Application No. 62/072,479, filed Oct. 30, 2014 and 62/134,058, filed Mar. 17, 2015, each of which is incorporated by reference in its entirety.

### FIELD

Embodiments disclosed herein relate to proppants, uses thereof, and methods of manufacture to combine proppants with coatings, particles, or functional agents.

### BACKGROUND

Hydraulic fracturing is an often used technique to increase the efficiency and productivity of oil and gas wells. Overly simplified, the process involves the introduction of a water-based, oil-based or emulsion fracturing fluid into the well and the use of fluid pressure to fracture and crack the well stratum. The cracks allow the oil and gas to flow more freely from the stratum and thereby increase production rates in an efficient manner.

There are many detailed techniques involved in well fracturing, but one of the most important is the use of a solid “proppant” to keep the stratum cracks open as oil, gas, water and other fluids found in well flow through those cracks. The proppant is carried into the well with the fracturing fluid which itself may contain a variety of viscosity enhancers, gelation agents, surfactants, etc. These additives also enhance the ability of the fracturing fluid to carry proppant to the desired stratum depth and location. The fracturing fluid for a particular well may or may not use the same formulation for each depth in the stratum.

Water produced during oil and gas operations constitutes the industry's most prolific by-product. By volume, water production represents approximately 98 percent of the non-energy related fluids produced from oil and gas operations, yielding approximately 14 billion barrels of water annually.

According to the American Petroleum Institute (API), more than 18 billion barrels of waste fluids from oil and gas production are generated annually in the United States. Such waste materials are often dissolved in subterranean water with a ratio of produced water to oil of about 10 barrels of produced water per barrel of oil. This waste water may include various ionic contaminants that include salt, hydrocarbons, heavy metals (e.g., zinc, lead, manganese, boron, copper, mercury, chromium, arsenic, strontium and aluminum), corrosive acids or bases from dissolved sulfides and sulfates, scale (e.g., insoluble barium, calcium and strontium compounds), naturally-occurring radionuclides (e.g., uranium, thorium, cadmium, radium, lead-210 and decay products thereof) often referred to as Naturally Occurring Radioactive Materials (NORMS), sludge (oily, loose material often containing silica and barium compounds) and dissolved radon gas. In general, the produced waters are re-injected into deep wells or discharged into non-potable coastal waters. Excluding trucking costs, waste water disposal can cost as much as $2 per barrel. Such costs must be factored into the overall economics of a gas field.

The NORMS contaminants are a matter of particular interest. Oil and gas NORM is created in the production process, when produced fluids from reservoirs carry sulfates up to the surface of the Earth's crust. Barium, calcium and strontium sulfates are larger compounds, and the smaller atoms, such as radium-226 and radium-228 can fit into the empty spaces of the compound and be carried through the produced fluids. As the fluids approach the surface, changes in the temperature and pressure cause the barium, calcium, strontium and radium sulfates to precipitate out of solution and form scale on the inside, or on occasion, the outside of the completion string and/or casings. The use of the completion string of tubular pipes in the production process that are NORM-contaminated does not cause a health hazard if the scale is inside the tubular string and the tubular string remain downhole. Enhanced concentrations of the radium-226 and -228 and the degradation products (such as Lead 210) may also occur in sludge that accumulates in oilfield pits, tanks and lagoons. Radon gas in the natural gas streams also concentrate as NORM in gas processing activities. Radon decays to lead-210, then to bismuth-210, polonium-210 and stabilizes with lead-206. Radon decay elements occur as a shiny film on the inner surface of inlet lines, treating units, pumps and valves associated with propylene, ethane and propane processing systems.

The waste water produced from a well should be reused or treated to remove the contaminants, especially the heavy metals. Oil wells are not, however, typically located next to substantial water treatment facilities. The waste water must be captured and transported to treatment facilities or portable facilities must be brought to the well. Exemplary systems have included packed beds of activated charcoal for the removal of organic compounds, permanent or portable ion exchange columns, electrodialysis and similar forms of membrane separation, freeze/thaw separation and spray evaporation, and combinations of these. All of these options are relatively costly with the water volumes produced from a production well.

The treatment of the waste water in the well has been attempted to be accomplished. See, for example, WO 2010/049467, U.S. Pat. No. 6,528,157, and U.S. Pat. No. 7,754,659. However, there is still a need for proppants with enhanced functionality that can be used not only to prop open the fractures that are produced, but also perform another function while in the well, such as decontaminating the waste water. The embodiments described herein provide for these as well as other needs.

### SUMMARY

Embodiments disclosed herein provide proppants that act as a proppant as well as perform other functions, such as filtering, cleaning, or treating water found within a well, such as a well for producing oil and/or gas.

Embodiments disclosed herein provide in-situ, downhole systems for removing dissolved contaminants, such as, but not limited to, dissolved forms of heavy metals and NORMs, at depth in an oil or gas well.

Embodiments disclosed herein provide processes that add additional functionality to a proppant solid, such as a coating or additional particle, to add chemical and/or mechanical benefits to the resulting proppant that would be of benefit to oil and gas well production. Examples of additional functionality, include, but are not limited to, a hydrophobic coating, a coating that inhibits the formation of scale, a biocidal coating, a coating that reduces friction, a coating that comprises a tracer, an impact modifier coating, a coating for timed or staged release of an additive, a coating that controls sulfides, one or more additional polymeric coatings, an acid or base resistant coating, a coating that inhibits corrosion, a coating that increases proppant crush resistance, a coating that inhibits paraffin precipitation, a coating that inhibits asphaltene precipitation, a coating comprising an ion exchange resin that removes anions and/or halogens, a coating or particulate that is effective to sequester or remove dissolved or suspended heavy metals from subterranean waters, a coating that inhibits hydrates and/or prevents hydrate agglomerates from forming, or a coating that contains and/or releases a compound that acts as a clay stabilizer. In some embodiments, the additional functionality is associated with the proppant solid as a chemically distinct solid that is introduced together with the proppant solid as an insoluble solid secured to the outer surface of the proppant solid with a coating formulation that binds the solids together, as a solid lodged within pores of the proppant solid, or as a chemical compound or moiety that is mixed into or integrated with a coating or the structure of the proppant solid.

In some embodiments, dual function proppants provide good conductivity in an oil or gas production well while also providing an additional property that is useful for oil and gas well production. Such dual function properties increase the value of the proppant and provide convenience for well engineers by eliminating an additional treatment step or two in the production process and/or help to address contaminants within the well or produced fluids that increase the operational costs of the well.

In some embodiments, methods of treating a fractured subterranean stratum are provided. In some embodiments, the methods comprise contacting the fractured stratum with a proppant that comprises a hydrophobic coating, a coating that inhibits the formation of scale, a coating that reduces friction, a coating that controls sulfides, an acid or base resistant coating, a coating that inhibits corrosion, a coating that inhibits paraffin precipitation, a biocidal coating, a coating that inhibits asphaltene precipitation, a coating that inhibits hydrates and/or prevents hydrate agglomerates from forming, or a coating that contains and/or releases a compound that acts as a clay stabilizer.

In some embodiments, methods of treating a fractured subterranean stratum are provided, wherein the method comprises contacting the fractured stratum with a proppant that comprises a hydrophobic coating, a coating that inhibits the formation of scale, a coating that reduces friction, a biocidal coating, a coating that controls sulfides, an acid or base resistant coating, a coating that inhibits corrosion, a coating that inhibits paraffin precipitation, a coating that inhibits asphaltene precipitation, a coating that inhibits hydrates and/or prevents hydrate agglomerates from forming, or a coating that contains and/or releases a compound that acts as a clay stabilizer.

The reduced friction can be used, for example, to generate less wear and tear on equipment, including in the pipes and other machinery that are used to transport the coated proppant to the well. The reduced friction can be also due to the presence of the hydrophobic coating. It has been surprisingly found that the presence of a coating that has reduced friction reduces the maintenance costs of the equipment and materials used to transport and inject the proppants into the fractured stratum. In some embodiments, the friction is reduced in the pipes and machinery used to transport the proppant or inject the proppant into the well. In some embodiments, the friction is reduced in fractured stratum, which can enable more efficient extraction of oil and gas products. In some embodiments, the proppant comprises a core solid having 1.5-12 wt % of a hard, glassy, cured, polyurethane coating over substantially the entirety of the surface of the core solid, wherein the polyurethane coating has been made with a multifunctional polyether polyol and an excess of an isocyanate and which develops an interparticle bond strength of at least 100 psi in unconfined compressive strength testing. In some embodiments, the interparticle bond strength is such that in a flowback test the bonded proppant has the strength to prevent flowback at downhole conditions of temperature, minimal closure stress (1000 psi) and at simulated production velocities. These conditions are known in the art. For example, a proppant flowback test utilizes a conductivity cell (described in the ISO 13503-5:2006; Procedures for measuring the long-term conductivity of proppants) or a larger modified cell. The apparatus simulates many of the processes occurring in the fracture to provide an accurate representation of the stability of the proppant consolidation. Frac fluid (proppant carrier) exposure, slurry placement, stress, cycling, temperature and fluid flow are all included to simulate real conditions. Proppant flowback testing includes, for example, injection of slurry of proppant into the modified conductivity cell. In some embodiments, high breaker loadings are used to ensure frac fluid break and minimize frac fluid damage. The crosslinked fluid is used to ensure placement into the cell under laboratory conditions but may not be required in the field dependent on specific conditions. The proppant pack is tested at a certain shut-in time, temperature and closure stress. During the test the fracture width is monitored. Brine (2% KCl) or a hydrocarbon is flowed through the pack to simulate production fluids flow through the porous media (proppant pack). The flow rate of the production fluids (brine or hydrocarbon, or mixtures thereof) is gradually increased to values way above realistic production rates until failure (if any), while the proppant pack is monitored for proppant production (flowback), pack movement or other indications of failure. The values of flow rate and differential pressure achieved, right before failure, directly correlate to a production fluids rate that the proppant pack can still be consolidated into the fracture and provide sufficient flowback control.

In some embodiments, proppants comprising a hydrophobic coating, a coating that inhibits the formation of scale, a coating that reduces friction, a coating that controls sulfides, an acid or base resistant coating, a coating that inhibits corrosion, a biocidal coating, a coating that inhibits paraffin precipitation, a coating that inhibits asphaltene precipitation, a coating that inhibits hydrates and/or prevents hydrate agglomerates from forming, a coating that contains and/or releases a compound that acts as a clay stabilizer, a coating that comprises a tracer, an impact modifier coating, a coating for timed or staged release of an additive, or any combination thereof are provided.

In some embodiments, resin-coated proppants that comprise a cured polyurethane coating associated with a polymeric treatment agent component, wherein the proppant comprises a core solid having a hard, glassy, cured, polyurethane coating over substantially the entirety of the surface of the core solid, wherein the polyurethane coating has been made with a multifunctional polyether polyol and an excess of an isocyanate and which develops an interparticle bond strength of at least 100 psi in unconfined compressive strength testing or can prevent flowback in a flowback test, such as where the minimal closure stress is 1000 psi, wherein the treatment agent component comprises: (a) a hydrophobic coating, (b) a coating that inhibits the formation of scale, (c) a coating that reduces friction, (d) a coating that comprises a tracer, (e) an impact modifier coating, (f) a coating for timed or staged release of an additive, (g) a coating that controls sulfides, (h) a polymeric coating other than a polymer formed from the first treatment agent, (i) an acid or base resistant coating, (j) a coating that inhibits corrosion, (k) a coating that increases proppant crush resistance, (l) a coating that inhibits paraffin precipitation, (m) a coating that inhibits asphaltene precipitation, (n) a coating comprising an ion exchange resin that removes anions and/or halogens, (o) a coating that inhibits hydrates, or prevents hydrate agglomerates from forming, (p) a coating that contains and/or releases a compound that acts as a clay stabilizer, or any combination thereof are provided.

### DESCRIPTION

In some embodiments, proppants are provided that include a proppant formulation that comprises a treatment agent component associated with a proppant particulate. The type of association encompasses various physical combinations of the proppant particulate and the treatment agent component, such as, but not limited to, unified proppant particulates in which the treatment agent component has been integrated into the structure of the proppant particulate as a chemical compound or moiety, an adsorbed liquid or finely divided solids disposed in pores within the proppant particulate, or adhered to the outside of the proppant particulate with a water insoluble binder coating; or a physical blend or mixture of proppant particulates and non-proppant particulates. The choice of how to impart the functionality upon the proppant can depend on the well, the fractured stratum and the nature of the contaminants to be removed from the produced fluids. It will be understood that the treatment agent component that is described herein for use with a proppant solid can also be used in the same manners with other solids that are employed in well operations. Examples of such other solids include gravel packs and sand filters of the types used in well completions. The gravel packing operation includes a transport of sand into the space between the screen and the casing, and into the perforation tunnels. The sand is sized to prevent fine particles or fines from the specific formation from passing through the pack (usually 20-40 mesh or 30-50 mesh or 40-60 mesh). The sand is deposited into the annulus behind the screen and then packed to create a filter to stop the fine particulate matter or fines from migrating into the wellbore. The screen openings are further sized to act as a final filter for any fines migrating through the sand bed. The treatment agent particles can be readily included in physical admixture with the gravel pack or filter sand particulates or adhered to them by way of a binder coating on the gravel pack or filter sand. They can perform as additional treatment agents as water and hydrocarbons issue from the fractured stratum.

In some embodiments, the treatment agent component or components can remove contaminants by any chemical, physical or biological method that is effective to remove the contaminant from the subterranean water associated with a fractured well. For example, the contaminant removal component in the proppant formulation can exhibit a functional affinity for the impurities in the water/hydrocarbon phase that pass through the fracture. Exemplary methods include ionic attraction, ionic exchange, sequestration, amalgamation, chelation, physical entrapment, absorption, adsorption, magnetic attraction, and adhesion. The specific method of removal that is most advantageous for a specific well depends on the nature and identities of the water contaminants that are produced from a specific well or the amount of contaminants expected to be present. Non-limiting examples of types of contaminant removal components include ion exchange resins, zeolites, and chemical compounds.

Ion Exchange Resins:

Synthetic ion exchange resins are often a crosslinked polymer network to which are attached ionized or ionizable groups. In the case of cation exchange resins, these groups are acidic groups (e.g., —SO₃H, —PO₃H₂, —CO₂M, and phenolic hydroxyl) while in anion exchange resins the groups are basic in character (e.g., quaternary ammonium, aliphatic or aromatic amine groups). In the synthesis of ion exchange resins, the ionizable and contaminant removal functional groups may be attached to the monomers or intermediates used in preparation of the crosslinked polymer, or they may be introduced subsequently into a preformed polymer. These are examples only and other anionic and cationic resins can be used.

Cation exchange resins are prepared, for example, by sulfonating styrene-divinylbenzene copolymers as described in U.S. Pat. No. 2,366,007. Strongly basic anion exchange resins can be prepared, for example, by treating crosslinked polystyrene with chloromethyl ether in the presence of a Friedel-Crafts catalyst. The chloromethylated product is then treated with a tertiary amine, e.g., trimethylamine, to give a resin containing strongly basic quaternary ammonium groups. The crosslinked polystyrene is generally a copolymer with up to about 10% divinylbenzene.

In some embodiments, the ion exchange resin is categorized as a strong acid cation exchange resin, a weak acid cation exchange resin, a strong base anion exchange resin, or a weak base anion exchange resin.

In some embodiments, the ion exchange resin is physically blended with proppant solids within the weight ratio range of about 1000:1 to about 1:1000, about 5000:2 to about 2:500, about 250:4 to about 4:250, or about 10:1 to about 1:10 of exchange resin to proppant. The specific weight ratio will depend on the relative densities of these materials, the carrying capacity of the resin and the contaminants found downhole. In some embodiments, ion exchange resins within the range of about 10-60 mesh (250-2000 m) are used for physical admixtures with proppant solids. In some embodiments, ion exchange resin solids can be disposed within pore openings or bound to the proppant solid with an exterior coating, adhesive or binder that resists dissolution under downhole conditions. In some embodiments, ion exchange resins within the range of about 10-400 mesh (38-2000 m) can be used for such combinations. In some embodiments, even smaller sizes can be used to meet the requirements of small pores within the proppant particulate.

Ion exchange resins can become spent as they are used to collect contaminants. Therefore, in some embodiments, these resins can be regenerated in situ by injecting an acidic solution into the fractured stratum containing the exchange resin. After a suitable recharge period, the discharge water that is laden with flushed contaminants is recovered as the well resumes production. See, for example, U.S. Pat. No. 7,896,080 whose disclosure is hereby incorporated by reference.

Molecular Sieves and Zeolites:

Compositionally, zeolites are similar to clay minerals. More specifically, both are alumino-silicates. They differ, however, in their crystalline structure. Many clays have a layered crystalline structure (similar to a deck of cards) and are subject to shrinking and swelling as water is absorbed and removed between the layers. In contrast, zeolites have a rigid, 3-dimensional crystalline structure (similar to a honeycomb) consisting of a network of interconnected tunnels and cages. Water moves freely in and out of these pores but the zeolite framework remains rigid. Another aspect of this structure is that the pore and channel sizes are nearly uniform, allowing the crystal to act as a molecular sieve. The porous zeolite is host to water molecules and ions of potassium and calcium, as well as a variety of other positively charged ions, but only those of appropriate molecular size to fit into the pores are admitted creating the “sieving” property.

One property of zeolite is the ability to exchange cations. This is the trading of one charged ion for another on the crystal. One measure of this property is the cation exchange capacity. Zeolites have high cation exchange capacities, arising during the formation of the zeolite from the substitution of an aluminum ion for a silicon ion in a portion of the tetrahedral units that make up the zeolite crystal. See, for example, U.S. Pat. Nos. 2,653,089; 5,911,876; 7,326,346; 7,884,043 and Published U.S. Patent Application Nos. 2004/010267 and 2005/018193. Other molecular sieves and adsorbents have been synthesized that appear to work well with NORMS-type contaminants. See U.S. Pat. Nos. 7,332,089 and 7,537,702. The disclosures of each of these references are hereby incorporated by reference.

Suitable molecular sieves and zeolites can be used in combination with the solids described herein. In some embodiments, molecular sieves and zeolites include pretreated or untreated natural and synthetic molecular sieves with pore size and exchange characteristics suitable for the contaminant to be removed, e.g., heavy metals. Examples of such zeolites include aluminosilicates such as clinoptilolite, modified clinoptilolite per U.S. Pat. No. 7,074,257, vermiculite, montmorillonite, bentonite, chabazite, heulandite, stilbite, natrolite, analcime, phillipsite, permatite, hydrotalcite, zeolites A, X, and Y; antimonysilicates; silicotitanates; and sodium titanates. In some embodiments, the sieves or zeolites are physically blended with proppant solid. In some embodiments, the sieves or zeolites are impregnated into the pores of the proppant solid. Any method of blending or impregnating into the pores can be used.

Chemicals:

Porous proppant particulates can be impregnated with one or more chemical compounds that have an affinity for binding with the contaminant targeted for removal. Examples of chemical compounds with an affinity for different contaminants include sulfonic acids, carboxylic acids, phenolics, aminoacids, glycolamines, polyamines, quaternary amines, polyhydroxylic compounds, and combinations thereof. In some embodiments, this functionality is made available at the surface of the coated particles to enhance contact with the ionic contaminant species and removal from solution.

Other Contaminant Removal Components:

In addition to the above, contaminants from water and hydrocarbons found in a fractured stratum can include activated carbon, non-molecular sieve adsorbent solids with an affinity for heavy metals and reactive materials that will form insoluble complexes or amalgams with the targeted metal ion contaminant species.

In some embodiments, the proppant is treated with other formulations, chemicals, or agents to provide a treated proppant with other properties of benefit for oil and gas wells. Such additional properties include but are not limited to, a hydrophobic coating, a coating that can function as a biocide (e.g. biocidal coating) a coating that inhibits the formation of scale, a coating that reduces friction, a coating that comprises a tracer, an impact modifier coating, a coating for timed or staged release of an additive, a coating that controls sulfides, a polymeric coating other than a polymer formed from the first treatment agent or coating, an acid or base resistant coating, a coating that inhibits corrosion, a coating that increases proppant crush resistance, a coating that inhibits paraffin precipitation, a coating that inhibits asphaltene precipitation, and a coating comprising an ion exchange resin that removes anions and/or halogens, a coating that inhibits hydrates and/or prevents hydrate agglomerates from forming, or a coating that contains and/or releases a compound that acts as a clay stabilizer. In some embodiments, the proppant is coated with a coating that delivers a biocide, a coating that delivers multiple chemicals or functional benefits, for example, a resin-coated proppant that can deliver a biocide and inhibits paraffin precipitation downhole. The coating can also have multiple functions.

Hydrophobic Coatings.

Water barriers are useful to prevent reaction or dissolution of proppant under acidic or basic conditions downhole. Chemical reactions of proppant are known to cause reductions in crush resistance, and potential scale formation through diagenesis, i.e., dissolution of the proppant and re-precipitation with dissolved minerals in the formation water.

A water resistant coating can be formed by contacting the proppant sand with an organofunctional alkoxysilane to develop a hydrophobic surface. Examples of organofunctional alkoxysilanes include, but are not limited to, waterborne or anhydrous alkyl or aryl silanes, triethoxy ((CH₃CH₂O)₃SiR), or trimethoxy ((CH₃O)₃SiR) where R represents a substituted or unsubstituted alkyl or substituted or unsubstituted aryl moiety. In some embodiments, silanes and chlorosilanes are used when, for example, a lower reaction temperature and higher speed of reaction are necessary. In some embodiments, HCl is generated as a byproduct of the treatment process, which may cause issues with corrosion, so corrosion-resistant treatment heads and handling equipment immediately after the chlorosilane treatment can be used.

If a hydrophobic and oleophobic surface is required, treatment of the proppant with a fluoroalkyl silane can be performed.

If a thicker cross-linked polymeric coating is needed for enhanced durability and hydrophobicity, a polymer can be applied after the silane treatment. In such a treatment, the silanes can include a triethoxy ((CH₃CH₂O)₃SiR), or trimethoxy ((CH₃O)₃SiR) silane, where the R would include a functional group that could either react with cross-linkable polymers after they are applied on the surface of the proppant, or would be chemically compatible with the polymer for van der Waals force of adhesion of the polymer. In some embodiments, R Groups for the silanes include:

amines (for preparation or polyurethanes, polyureas, polyamides, polyimides or epoxies. Amines may also be used for polysulfones);

isocyanates (for polyurethane, polyurea coatings);

vinyl (for reaction with polybutadiene, polystyrenebutadiene, other addition type olefinic polymers, or reaction with residual vinyl groups in any copolymer blends used as coatings);

epoxides (for reaction with epoxies);

methacrylate or ureido groups (for polyacrylates); and

phenyl groups (for use with aromatic-containing polymers such as the polyaryletherketones (PAEKs) and their composites such as polyetherketoneketone (PEKK)/50:50 terephthallic:isothallic/amorphous polyetherketoneetherketoneketone (PEKEKK), polyethersulfone (PES), polyphenylsulfone (PPSU), polyetherimine (PEI), or poly(p-phenylene oxide) (PPO)).

In some embodiments, the thicker, cross-linked, polymeric coatings can be prepared by a first step of application of silanes, followed by a second step of coating with the polymer, prepolymers, or monomers. In some embodiments, catalysts can be used for inducing reactions at typical operating temperatures of the coating process, i.e., room temperature to 85° C. In general, methoxysilanes tend to react faster than ethoxy silanes, so methoxysilanes can be used for fast, flash-type coatings. If speed of reaction of the silane treatment is a limiting factor for proper coating, chlorosilanes can be used as substitutes for methoxy or ethoxysilanes, as long as corrosion resistant materials are used in the application process. An example of a flash-coating process is provided in PCT Application No. PCT/US2014/063086, entitled, “Flash Coating Treatments For Proppant Solids,” filed Oct. 30, 2014, Argentina Application No. 20140104080, filed Oct. 30, 2014, and U.S. application Ser. No. 14/528,070 filed Oct. 30, 2014, each of which is hereby incorporated by reference in its entirety. The flash coating process described therein can be used in conjunction with any of the embodiments described herein.

In some embodiments, methods for forming coatings of high temperature aromatic polymers use a solvent-based slurry or fully dissolved solution. Non-limiting examples of solvents include N-methylpyrrolidone (NMP), dimethylformamide (DMF), and dimethylsulfoxide (DMSO). If excess solvents remain after application, they can be removed via a drying step prior to transfer into containers for shipment.

Scale Inhibition.

By applying scale inhibitors directly to the proppant, the coated proppants can provide a targeted, positionable, anti-scale treatment on the relatively large surface area of the proppants in fractured strata. With a large portion of the active surface area treated, the effective surface area where scale can form is reduced. Additionally, the compounds can prevent scale formation in the spaces between proppant particles (i.e., pores) where scale deposits can have a large negative impact on proppant conductivity.

Several polymeric substances can be used on proppants to inhibit scale formation, including phosphino-polycarboxylates, polyacrylates, poly vinyl sulphonic acids, and sulphonated polyacrylate co-polymers. Previously, these polymers had to be injected into the formation where they would then disperse to be effective. See, for example, U.S. Pat. No. 5,092,404. Such injections often lead to a substantial volume of the inhibitor being produced back out of the well early in the production cycle. By applying the scale inhibitor to the proppant, this can be avoided.

Examples of non-polymeric scale inhibitors include, but are not limited to, carboxylates and acrylates. These inhibitors can be applied, for example, to the surface of a proppant in a similar manner to those other functional coatings described above. Also suitable are fumaric acid (CAS 110-17-8), Diethylene Glycol (CAS 111-46-6), phosphorous acid (CAS 13598-36-2), trisodium 2,2′-({2-[(carboxylatomethyl)amino]ethyl}imino)diacetate (CAS 19019-43-3), sodium glycolate (CAS 2836-32-0), glycine (CAS 38011-25-5), trisodium nitrilotriacetate (CAS 5064-31-3), 1,2-propylene glycol (CAS 57-55-6), methoxyacetic acid (CAS 625-45-6), methylphosphonic acid (CAS 6419-19-8), polyphosphoric acids (CAS 68131-71-5), alkylbenzene (CAS 68648-87-3), phosphino-carboxylic acid (CAS 71050-62-9), trisodium ortho phosphate CAS 7601-54-9), or sodium polyacrylate (CAS 9003-04-7).

If additional adhesion to the proppant surface is needed due to too high of a solubility of the scale-inhibiting polymer in the production fluid, amines or ureidosilanes can be used as tethering agents for the acrylates and carboxylates. Full chemical bonding might also be possible by adding a vinyl silane, and also retaining some vinyl functionality in the carboxylates, acrylates, and polyvinylphosphonic or polyvinylsulfonic acids. Peroxides can be used to initiate coupling of the vinyl silane with the vinyl polymer treatment, via addition of the peroxide in the second treatment, and applying it to a heated substrate. In addition, additives can be mixed with inert polymers to be sprayed to impart scale reduction functionality to the coatings. They could also be imbedded in water soluble polymers to allow timed release of the scale additives. The release time of the additives from the polymeric coating can be adjusted by modifying the swell rates of the polymer via adjustments to the cross-link density or density of concentrations of hydrophilic moieties on the polymer backbones.

Friction Reduction.

Currently, when those in the industry refer to “friction reduction” they are talking about the friction pressure generated when moving the frac fluid down the well, typically through tubular conduits to the formation to be treated. Of the mechanisms for friction reduction, the most accepted is thought to involve a reduction in turbulent flow due to the presence of stretched oligomers or high molecular weight polymers that extend into the fluid and disrupt the formation of turbulent eddies in the flowing fluid, often along the walls of a conduit.

Accordingly, in some embodiments, a proppant treatment for reduced friction can take the form of a released, high molecular weight polymer that will can help with fugitive dust control above ground and also releases from the proppant into the frac fluid where it serves a second function as a turbulence reducer.

In some embodiments, a direct coating of the proppant with one or more releasable or dissolvable polymers can deliver the turbulence-reducing agents for the well via a surface on the proppant. The coating can be designed to release the turbulence-reducing agents immediately or after some time delay. If delayed, such a coating can help reduce the volume of turbulence-reducing polymers in the frac fluid and avoid the associated deposits and loss of conductivity that can accompany such excess quantities. Once the proppant is placed in the fracture, the delayed dissolution or release of the polymeric turbulence-reducing coating on the proppant occurs in-situ for enhanced control and reduced opportunities for unintended deposits and accumulations of polymeric agents.

In some embodiments, the turbulence-reducing coatings can be designed by those in this art for immediate release via use of water soluble polymers, or for timed release via tailoring of the water soluble polymer for delayed swelling. Materials that can be used for friction-reducing coatings include, but are not limited to, ethoxylated oleylamine (CAS 26635-93-8), caprylic alcohol (CAS 111-87-5), C₆₋₁₂ ethoxylated alcohols (CAS 68002-97-1), C₁₂₋₁₄ ethoxylated alcohols (CAS 68439-50-9), C₁₂₋₁₆ ethoxylated alcohols (CAS 68551-12-2), polyacrylamide (CAS 25085-02-3), copolymer of acrylamide and sodium acrylate (CAS 25987-30-8), acrylamide/ammonium acrylate copolymer (CAS 26100-47-0), acrylamide/sodium acryloyldimethyltaurate copolymer (CAS 38193-60-1), 2-propenamide, polymer with 2-propenoic acid and sodium 2-propenoate (CAS 62649-23-4), ammonium sulfate (CAS 7783-20-2), acrylamid (CAS 79-06-1), PTFE (Teflon®) (CAS 9002-84-0), polyacrylamide (CAS 9003-05-8), poly(acrylamide-co-acrylic acid) (CAS 9003-06-9), or any combination thereof. In some embodiments, the water soluble polymer is a guar gum, a guar derivative, or a combination thereof, or in combination with another water soluble polymer described herein.

In the so-called “water fracs” where there is no frac fluid system and only a friction reducer in water, the concentration of the friction reducer is very low (<5 lb/1000 gallons). In such a case, the turbulence-reducing polymer is less likely to cause significant damage but surface friction along the proppant pack pores can retard flow and thereby reduce conductivity. Therefore, in some embodiments, the proppant can have a second type of coating having hydrophobic and/or oleophobic properties to allow flowing fluids to slide off the proppant surfaces and through the pore spaces. A coating that is either hydrophobic and/or oleophobic would permit both materials to move by with reduced friction.

Treatment in this manner can also result in improvement in removal of static water trapped in the interstices of the proppant particle surface and between the particles. This can help minimize water lock, and thus improve overall hydrocarbon production from a well by reducing the surface tension and the amount of force needed to remove the water from the pores and allow hydrocarbons to flow through the proppant pack.

Suitable materials for coating the proppant with such hydrophobic and/or oleophobic agents include, but are not limited to, superhydrophobic coatings such as those found in U.S. Pat. No. 8,431,220 (hydrophobic core-shell nano-fillers dispersed in an elastomeric polymer matrix); U.S. Pat. No. 8,338,351 (hydrophobic nanoparticles of silsesquioxanes containing adhesion promoter groups and low surface energy groups); U.S. Pat. No. 8,258,206 (hydrophobic nanoparticles of fumed silica and/or titania in a solvent); and U.S. Pat. No. 3,931,428 (hydrophobic fumed silicon dioxide particles in resin) and the durable hydrophobic coatings of U.S. Pat. No. 8,513,342 (acrylic polymer resin, polysiloxane oil, and hydrophobic particles); U.S. Pat. No. 7,999,013 (a fluorinated monomer with at least one terminal trifluoromethyl group and a urethane resin); and U.S. Pat. No. 7,334,783 (solid silsesquioxane silicone resins). Additional materials that can be used include aliphatic or aromatic polymers that exhibit water contact angles of greater than about 90°, such as polybutadiene-containing polymers, polyurethanes with high proportions of soft segments (e.g., aliphatic segments), polymethylmethacrylate, and siloxane resins, including polydimethylsiloxane.

The use of a hydrophobic coating on the proppant may also have the effect of preventing water from reaching the surface of the sand grain. Therefore, a hydrophobic coating can be added to slow down or minimize the detrimental effects that are observed with increased temperature in water-rich environments like those found downhole. The hydrophobic coating, can for example, prevent a decrease in the sands conductivity that otherwise would have been observed for uncoated sand with an increasing temperature that may be found in a well. The hydrophobic coating can also prevent the damage to the proppant that can be seen due to the combination of elevated temperatures and contact with water.

If some embodiments, the proppant is coated with multiple coatings. In some embodiments, the proppant is coated with a first layer of hydrophobic/oleophobic coating followed by a turbulence-reducing coating. Such a layered structure can permit the treated proppant to both reduce turbulence from separation of the top layer and then reduce surface drag by the flowing fluids by the underlying layer.

Friction reducing coatings can also take the form of materials with a low external, interparticle friction that function as a slip aid. A suitable material for use as such a slip aid is a product sold under the tradename POLYOX from Dow Chemical. This material is a non-ionic water-soluble poly(ethylene) oxide polymer with a high-molecular weight.

Tracer Coatings.

Tracers are radioactive isotopes or non-radioactive chemicals that are injected in a well at specific sites with the intent that they will come out in detectable levels at some point in the effluent. Thus, they allow flow tracking of injected fluids from the source of introduction to the effluent stream. In addition, tracers that are location-specific can be used to track production of fluids from specific areas/zones in a well. Often, the tracers are introduced as an additive into the fracturing fluid during completion of a particular zone of interest.

Common radio-isotope chemistries used as tracers include tritiated water (³H₂O); tritiated methane (³CH₄); ³⁶Cl—; ¹³¹I—; ³⁵SO₄²⁻; S¹⁴CN⁻; H¹⁴CO³⁻; and ²²Na⁺.

Common non-radioactive tracer chemicals include halohydrocarbons, halocarbons, SF₆, and cobalt hexacyanide, where the cobalt is present as an anionic complex because cationic cobalt can react and precipitate downhole. Various organic compounds of usefulness include sulfonic acids and salts of those acids, mapthalenediol, aniline, substituted analine, and pyridine.

Tracers can be embedded in proppants but usually require actual movement of the proppant particle out of the well (i.e., flowback). The tagged proppant particle itself is then collected as a sample and analyzed for the presence/absence of the tracer. See U.S. Pat. Nos. 7,921,910 and 8,354,279. Others have sought to incorporate non-radioactive tagging chemicals into the proppant resin coating, but such an introduction method has required custom proppant formulations that must be manufactured well in advance of planned usage in a particular well. This can cause issues as the reactive phenolic coated proppants can sometimes have short useful shelf life as the taggants must be released before the phenolic resin becomes fully cured.

One feature in common among the tagged proppant techniques to date is that all of them required substantial pre-planning for production of multiple, different, tagged proppants for different well zones in advance of injection. For example, if five different zones need to be mapped, five different tagged proppant formulations might be needed. This means that five different types of proppants must be prepared at the resin coating plant and stored in inventory by either the proppant manufacturer or by the well completion group.

In some embodiments, the coating process can occur quickly and with such small amounts of applied polymers, resins, or organic compounds that the same tracers, metals, salts and organic compounds could be used as have been used previously in resin coating facilities. Additionally, new polymers or oligomers can be used that contain specific functional groups that have not been previously used, such as fluorescent dyes or phosphorescent pigments that can be detected in even small quantities in produced effluent, whether water or hydrocarbon. Suitable fluorescent include coumarins, napthalimides, perylenes, rhodamines, benzanthrones, benzoxanthrones, and benzothioxanthrones. Phosphorescent pigments include zinc sulfide and strontium aluminate. The coating used in the present process can be tailored to allow for selective or timed release leaching of the tracer salts from the coating into the downhole environment. This would allow the effluent to be used for analysis rather than requiring an analysis of recovered proppants in the flowback. In addition, very short lead times can be gained through use of this process, to allow greater flexibility for the customer to specify numbers of different tagging sections needed in a particular well. The coatings described herein can be applied immediately before moving the sand from terminals into containers for shipment to the well pad. This means that the inventory is reduced to the containers of tracer agent.

Some metal agents, e.g., tin and copper, that were previously used as biocides can also serve the function of a tracer in a proppant coating.

In some embodiments, polymers to prepare tracer coatings include acrylate copolymers with hydrolysable silylacrylate functional groups, such as those described by U.S. Pat. No. 6,767,978. Briefly described, such polymers are made from at least three distinct monomers units selected from the group consisting of fluorinated acrylic monomers, (e.g., 2,2,2-Trifluoroethylmethacrylate (matrife)), triorganosilylacrylic monomers, (e.g., trimethylsilyl methacrylate) and acrylic monomers not containing an organosilyl moiety, (e.g., methyl methacrylate). The three component polymer (i.e., terpolymer) can optionally contain from 0-5 weight percent of a cross-linking agent. Such polymers are a copolymers comprising the reaction product of:

a) a monomer of the formula:

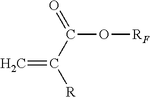

wherein:

R is CH₃ or H, and

RF is (C)ᵤ(CH)ᵥ(CH₂)_{w}(CF)ₓ(CF₂)_{y}(CF₃)_{z} where u is from 0 to 1, v is from 0 to 1, w is from 0 to 20, x is from 0 to 1, y is from 0 to 20, z is from 1 to 3, and the sum of w and y is from 0 to 20,

b) a monomer of the formula:

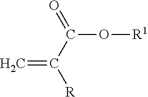

wherein R is CH₃ or H, and R¹ alkyl or aryl, and

c) a monomer of the formula:

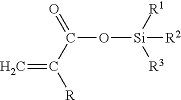

wherein:

R is CH₃ or H, and

R¹, R², and R³ can be the same or different and are non-hydrolysable alkyl groups containing from 1 to 20 carbon atoms and/or non-hydrolysable aryl groups containing from 6 to 20 carbon atoms.

In addition, depending on the chemistry used, metal-containing tracer moieties might also be used as biocides, similar to marine antifouling coatings. For example, tin and copper are commonly used as biocides in marine paints. These metals or their salts could also be incorporated into the acrylate latexes for coating onto the proppant or added to insoluble polymers for permanent attachment to the exterior of the proppant surface.

Suitable water soluble and dissolvable polymers are described in U.S. Pat. No. 7,678,872. Such polymers can be applied to proppants according to any process and can allow for the introduction of timed release functionality of the tracers into the produced fluid as the polymer swells or dissolves while also serving to control fugitive dust from the proppant.

Impact Modifiers.

Fines in a well can severely affect the conductivity of a proppant pack. Production of 5% fines can reduce conductivity by as much as 60%. Particle size analysis on pneumatically transferred 20/40 sand with a starting fines distribution of 0.03% showed an increase in fines to 0.6% after one handling step, and 0.9% after two handling steps prior to shipment to a well pad. Transport and further handling at the well site will likely also produce significantly more impact-related fines.

The processes described herein can be used to coat proppants with polymers specifically designed to be more deformable, which will greatly aid in the reduction of impact induced fines production. These polymers reduce the number of grain failures when closure stress is applied, effectively increasing the K value of the proppant, and can reduce fines migration by keeping failed grains encapsulated.

There are at least three ways that a thin, deformable coating on a proppant can improve fracture conductivity. The first is a benefit addressing the handling process. An additive that controls/prevent the generation of dust (through handling and pneumatic transfer) is helping to minimize the generation and inclusion of fine particles that are created through movement of such an abrasive that material as uncoated sand. Without wishing to be bound by any theory, the process that causes the creation of fines is simultaneously creating weakened points everywhere the grain was abraded. Conductivity tests have documented that uncoated sand samples that were moved pneumatically had measurably lower conductivity than the same sand not so handled. The impact-modifying polymer coating can further reduce grain failure by spreading out point-to-point stresses that occur when one grain is pushed against another during the closure of the fracture and subsequent increase of closure stress that occurs as the well is produced. The deformable coating effectively increases the area of contact between two grains. This increase in contact area reduces the point loading that is trying to make the grains fail. Minimizing the generation of fines that occur either during handling or from the pressure applied in the fracture, will mean there are less fines that can be mobilized to create conductivity damage. If the flash coating results in a uniformly distributed film around the sand grain, the coating can be an effective means of preventing fines movement through the encapsulation of any failed grains. Preventing or minimizing the movement of fines can result in controlling a condition that has been proven to be capable of reducing fracture conductivity by as much as 75%.

In some embodiments, for an impact modified layer, the layer comprises lower Tg polyurethanes or lightly crosslinked polyurethanes. The polyurethane formula could be tailored for lower Tg and better resilience by using a very soft polyols (e.g., polybutadiene-based polyols with very light crosslinking). Another embodiment uses the application of a thin coating of polybutadiene polymer as the impact layer. Such a flash coating is applied with either a latex-based or solvent-based formulation, and a peroxide for lightly curing/cross-linking the polybutadiene coating. Other embodiments include, but are not limited to, other rubbery polymers including polyisoprene, polychloroprene, polyisobutylene, cross-linked polyethylene, styrene-butadiene, nitrile rubbers, silicones, polyacrylate rubbers, or fluorocarbon rubbers. The rubber or gum should be in a water-based latex or dispersion or dissolved in a solvent for spray application.

Polybutadiene coatings with unreacted vinyl or alkene groups can also be crosslinked through use of catalysts or curative agents. When catalysts, fast curatives, or curatives with accelerants are introduced during processes described herein, the result will be a very hard, tough coating. Alternately, curative agents can be added that will activate thermally after the materials are introduced downhole at elevated temperatures. This may have the effect of having a soft rubbery coating to protect against handling damage, but that soft rubbery coating could then convert to a hard coating after placement downhole at and cured elevated temperatures.

Curative agents that can be used are those that are typically used for rubbers, including sulfur systems, sulfur systems activated with metal soaps, and peroxides. Accelerators such as sulfonamide thiurams or guanadines might also be used, depending on cure conditions and desired properties. Other curing catalysts could also be employed to perform similarly include ionic catalysts, metal oxides, and platinum catalysts. Additive Delivery. “Self-suspending proppants” can have an external coating that contains a water swellable polymer that changes the proppant density upon contact with water. See, for example, US 2013/0233545. Such coatings are taught to have about 0.1-10 wt % hydrogel based on the weight of the proppant and can contain one or more chemical additives, such as scale inhibitors, biocides, breakers, wax control agents, asphaltene control agents and tracers.

In some embodiments, the water swellable polymer can be applied by processes described herein and present at a much lower concentration, e.g., less than about 0.1 wt %, or from about 0.001 to about 0.07 wt %. At such low levels, the swellable coating is unlikely to produce a self-suspending proppant but, rather, imparts enhanced mobility relative into the fracture to untreated sand while also providing dust control as well as a delivery system upon contact with water for biocides and tracers. For example the swellable polymer coating could act as a dust control when first applied, could swell to enhance mobility for placement, and could also contain tracers, biocides, or other active ingredients that could be released over time through diffusion out of the swollen polymer.

Soluble and semi-soluble polymers that can be used as delivery coatings include, but are not limited to, 2,4,6-tribromophenyl acrylate, cellulose-based polymers, chitosan-based polymers, polysaccharide polymers, guar gum, poly(1-glycerol methacrylate), poly(2-dimethylaminoethyl methacrylate), poly(2-ethyl-2-oxazoline), poly(2-ethyl-2-oxazoline), poly(2-hydroxyethyl methacrylate/methacrylic acid), poly(2-hydroxypropyl methacrylate), poly(2-methacryloxyethyltrimethylammonium bromide), poly(2-vinyl-1-methylpyridinium bromide), poly(2-vinylpyridine n-oxide), polyvinylpyridines, polyacrylamides, polyacrylic acids and their salts (crosslinked and partially crosslinked), poly(butadiene/maleic acid), polyethylenglycol, polyethyleneoxides, poly(methacrylic acids, polyvynylpyrrolidones, polyvinyl alcohols, polyvinylacetates, sulfonates of polystyrene, sulfonates ofpolyolefins, polyaniline, and polyethylenimines, or any combination thereof.

Biocidal Coatings.

A number of nonpolymeric biocides have been used in fracturing fluids. Any of these can be used in solid forms or adsorbed into solid or dissolvable solid carriers for use as additives in an applied coating according to the present disclosure to impart biocidal activity to the proppant coatings. Exemplary biocidal agents include, but are not limited to: 2,2-dibromo-3-nitrilopropionamide (CAS 10222-01-2); magnesium nitrate (CAS 10377-60-3); glutaraldehyde (CAS 111-30-8); 2-bromo-2-cyanoacetamide (CAS 1113-55-9); caprylic alcohol (CAS 111-87-5); triethylene glycol (CAS 112-27-6); sodium dodecyl diphenyl ether disulfonate (CAS 119345-04-9); 2-amino-2-methyl-1-propanol (CAS 124-68-5); ethelenediaminetetraacetate (CAS 150-38-9); 5-chloro-2-methyl-4-isothiazolin-3-one (CAS 26172-55-4); benzisothiazolinone and other isothiazolinones (CAS 2634-33-5); ethoxylated oleylamine (CAS 26635-93-8); 2-methyl-4-isothiazolin-3-one (CAS 2682-20-4); formaldehyde (CAS 30846-35-6); dibromoacetonitrile (CAS 3252-43-5); dimethyl oxazolidine (CAS 51200-87-4); 2-bromo-2-nitro-1,3-propanediol (CAS 52-51-7); tetrahydro-3, 5-dimethyl-2h-1,3,5-thia (CAS 533-73-2); 3,5-dimethyltetrahydro-1,3,5-thiadiazine-2-thione (CAS 533-74-4); tetrakis hydroxymethyl-phosphonium sulfate (CAS 55566-30-8); formaldehyde amine (CAS 56652-26-7); quaternary ammonium chloride (CAS 61789-71-1); C₆-C₁₂ ethoxylated alcohols (CAS 68002-97-1); benzalkonium chloride (CAS 68424-85-1); C12-C14 ethoxylated alcohols (CAS 68439-50-9); C12-C16 ethoxylated alcohols (CAS 68551-12-2); oxydiethylene bis(alkyldimethyl ammonium chloride) (CAS 68607-28-3); didecyl dimethyl ammonium chloride (CAS 7173-51-5); 3,4,4-trimethyl oxazolidine (CAS 75673-43-7); cetylethylmorpholinium ethyl sulfate (CAS 78-21-7); and tributyltetradecylphosphonium chloride (CAS 81741-28-8), or any combination thereof.

Alternatively, an erodible outer coating with a timed release or staged release can be used that will dissolve and/or release included additives into the groundwater or hydrocarbons downhole. Such coatings can be based on polymers that were substantially insoluble in cool water but soluble in water at downhole temperatures where the active is intended to begin functioning shortly after introduction. Alternatively, the outer layer coating can be prepared in such a way as to render it insoluble in the well fluids and subject to release when crack closure stresses are applied.

The time frame for release of an encapsulated ingredient (biocide, scale inhibitor, etc.) via diffusion can be tailored based on the cross-link density of the coating. A polymer with little to no cross-linking can result a fast dissolving coating. Highly cross-linked materials can have a much slower release of soluble ingredients in the coating. If mobility of the chemicals of interest is too low in a cross-linked membrane, dissolvable fillers like salts, organic crystalline solids, etc. can be incorporated in the coating mixture. Once the coated proppant is introduced downhole, the particles can dissolve to leave larger pores as done for filtration membranes. See U.S. Pat. No. 4,177,228. Insoluble polymers like the thermosets (e.g., alkyds, partially cured acrylics, phenolics, and epoxies) and thermoplastics (e.g., polysulfones, polyethers, and most polyurethanes) can also be used as insoluble outer coatings applied as described herein. Alkyds, which are polyesters, are likely to hydrolyze over time under the hot, wet downhole conditions and can thereby use this property to impart a delayed release through combination of environmental hydrolysis and situational erosion. Polyamides, which can hydrolyze and degrade over time, can be used as well for this type of coating.

Coatings can be prepared by mixing thermoset polymers with the soluble fillers and applying them to the proppant particles according to the various embodiments described herein. Thermoplastic membrane coatings can be applied via dissolving in solvent, mixing with the soluble fillers, and coating the resulting mixture onto the proppant particles with subsequent removal of the solvent by drying with pneumatic conveyance air or air forced through the coated materials. Timings for release can be tailored by proper selection of filler size, shape, and filler concentration.

Biocidal polymer coatings. Biocides are often used at low concentrations in the hydraulic fracturing fluid mixtures, on the order of 0.001% in the fracturing fluid, which corresponds to approximately 0.01% of the total proppant weight. Microorganisms have a significant economic impact on the health and productivity of a well. For example, unchecked bacteria growth can result in “souring” of wells, where the bacteria produces hydrogen sulfide as a waste product of their metabolic function. Such sour gases in the produced fluids are highly undesirable and can be a source for corrosion in the production equipment as well as a cost for sulfur removal from the produced hydrocarbons.

Therefore, in some embodiments, a biocidal polymer can be applied to the proppants as an aid to both fugitive dust control as well as inhibition of bacterial growth downhole. Suitable polymers that can be used as biocides include: acrylate copolymer, sodium salt (CAS 397256-50-7), and formaldehyde, polymer with methyloxirane, 4-nonylphenol and oxirane (CAS63428-92-2), or any combination thereof.

In addition, depending on the chemistry used, metals used as marine antifouling coatings can also serve as biocides on a proppant. For example tin and copper are commonly used as biocides in marine paint. These same agents could be incorporated into the acrylate latexes for flash coating onto the proppant as a biocidal coating.

Sulfide Control.

Hydrogen sulfide is a toxic chemical that is also corrosive to metals. The presence of hydrogen sulfide in hydrocarbon reservoirs raises the cost of production, transportation and refining due to increased safety and corrosion prevention requirements. Sulfide scavengers are often used to remove sulfides while drilling as additives in muds or as ingredients in flush treatments.

Depending on the concentration of hydrogen sulfide in the fractured reservoir, the concentrations of the scavengers included on the surface of the proppant can be varied to remove more or less hydrogen sulfide. In sufficient volume, proppants with sulfide scavenging capabilities can reduce the concentration from levels that pose safety hazards (in the range of 500-1000 ppm) to levels where the sulfides are only a nuisance (1-20 ppm). If the surface area of the proppants is high and dispersion of the scavengers is good, high efficiencies in hydrogen sulfide reaction and removal are possible.

A timed release dosage can be delivered according to the present disclosure by including copper salts, such as copper carbonate (CuCO₃), in the proppant that can be delivered very slowly into the fracture to treat hydrogen sulfide before it can reach steel components in the wellbore.

Zinc oxide (ZnO) and ferric oxide (Fe₂O₃) are used directly as solid particulates to address hydrogen sulfide. These can be incorporated onto the surface of coated proppants or be formed as functional fillers within the proppant coating that is applied. The use of high surface area fillers, even nanometer-sized particulates, can be used to maximize the interaction area between the hydrogen sulfide and the metal oxide.

Also useful are oxidizing agents, such as solid forms of oxidizing agents. Exemplary materials include solid permanganates, quinones, benzoquinone, napthoquinones, and agents containing quinone functional groups, such as chloranil, 2,3-dichloro-5,6-dicyanobenzoquinone, anthroquinone, and the like, or any combination thereof.

Polymers with pendant aldehyde groups can also be used introduce an aldehyde functionality in a proppant coating for control of hydrogen sulfides. Polyurethanes can be made with such functionalities. See U.S. Pat. No. 3,392,148. Similarly, other polymers can be formed with pendant aldehyde groups, such as polyethers, polyesters, polycarbonates, polybutadiene, hydrogenated polybutadiene, epoxies, and phenolics, or any combination thereof.

In addition, dendrimers can be prepared with multiple terminal aldehyde groups that are available for reaction. These aldehyde-rich dendrimers can be used as fillers, copolymers, or alloys and applied to the proppants as a coating, or a layered coating.

Dioxole monomers and polymers allow introduction of this functionality as pendant groups in polymers. Such dioxane functional groups can serve as oxidative agents to control the production of hydrogen sulfides. Homopolymers of dioxole can be used as well as copolymers of dioxoles with fluorinated alkenes, acrylates, methacrylates, acrylic acids and the like.

Amines and triazines also used as scavengers for hydrogen sulfide. Amine-terminated polymers or dendrimers can be used and have the advantage of being tethered to a polymer so they can stay in place in a proppant coating. High functionality can be achieved by the use of dendrimers, i.e., using multiple functional groups per single polymer molecule.

Triazines can be incorporated into polyurethane cross-link bridges via attachment of isocyanates to the R groups of the triazines. See U.S. Pat. No. 5,138,055 “Urethane-functional s-triazine crosslinking agents”. Through variations of the ratio of —OH groups and the use of triol functionality and monofunctional triazine isocyanate, pendant triazines can also be prepared. These functionalized polymers can be added as fillers or prepared as the coating itself to both impart fugitive dust control as well as hydrogen sulfide control downhole.

Metal carboxylates and chelates, some of which are based on or containing zinc or iron, can be used on proppants to remove hydrogen sulfide. See U.S. Pat. No. 4,252,655 (organic zinc chelates in drilling fluid). These carboxylates or chelates are provided in the proppant coating as water soluble complexes which, upon interaction with hydrogen sulfide in-situ downhole, will form insoluble metal sulfates.

Hydrogen sulfide can also be controlled with polymers having functional groups that can act as ligands. Polycarboxylates that have been pretreated with metals to create metal carboxylate complexes can be mixed with other polymers, such as those described elsewhere herein, and applied as a coating to proppant particles. This is also applicable to other polymers with pendant functional groups that act as complexing ligands for sulfide, such as amines and ethers.

In some embodiments, the metals used for sulfide control are not present as a complex in the polymeric backbone so that removal of the metal would not have to involve polymer decomposition. Polymers with metal side chain complexes can be used. Polyvinylferrocenes, polyferrocenylacrylates are two such examples of this class of material. In some embodiments, the main chain metal containing polymer can also be used, but the polymer will degrade upon reaction with hydrogen sulfide.

If the production fluid which contains hydrogen sulfide at a basic pH (i.e., pH of greater than 7 or greater than 8-9), most of the hydrogen sulfide will be present as HS-anion. In this case, anion exchange resins or zeolites can be used to extract the HS-anions from the fluid. The zeolites or anionic exchange resins can be used as active fillers in a resin coated proppant composition include aluminosilicates such as clinoptilolite, modified clinoptilolite, vermiculite, montmorillonite, bentonite, chabazite, heulandite, stilbite, natrolite, analcime, phillipsite, permatite, hydrotalcite, zeolites A, X, and Y; antimonysilicates; silicotitanates; and sodium titanates, and those listed in U.S. Pat. No. 8,763,700, the disclosure of which is hereby incorporated by reference. Suitable ion exchange resins are generally categorized as strong acid cation exchange resins, weak acid cation exchange resins, strong base anion exchange resins, and weak base anion exchange resins, as described in U.S. Pat. No. 8,763,700. Hydrogen sulfide that is produced through biological activity is controlled through use of biocides and biocidal coatings (as discussed above), and removal of sulfate anions (HSO₄⁻ or SO₄⁻²). Anion exchange resins can be used for removal of sulfate. Nitrates can also be used to disrupt the sulfate conversion by bacterial. Nitrate salts can also be added in a coating layer and then protected from premature release with an erodible or semipermeable coating to allow an extended release of the nitrates.

Composite Coatings.

In some embodiments, the processes described can be carried out effectively in series, and such a process provides a cost-effective process to apply multiple layers of coatings with different compositions and different functional attributes. A variety of combinations are possible. For example, in some embodiments, multiple spray heads, each of which can apply a different formulation. If the successive coating formulation is chemically incompatible in that the applied layer does not wet the undercoated layer, one or more primer agents, e.g., block or graft copolymers with similar surface energies and or solubility parameters as the two incompatible layers, can be used for better interfacial bonding. The different spray heads can also be used to apply the same formulation if multiple layers are desired. Some examples of composite coatings include the following.

Two layers for improved proppant physical performance. Different, successive layers are applied with different performance characteristics, such as a hard urethane layer (urethane, cross-linker (such as polyaziridine), and isocyanate) followed by an outer, softer urethane layer. This coating structure can allow some compaction for proppant particle bonding due to the soft outer layer but inhibit further compaction/crushing due to the hard inner layer. The relatively softer outer layer can also tend to reduce interparticle impact damage as well as wear damage on the associated handling and conveying equipment used to handle the proppants after the flash coating was applied.

Successive layers for a timed release functionality. Successive layers can be used to add a first layer with an additive having a first functionality followed by a second layer having properties that control when and how ambient liquids get access to the first layer additive materials. For example, a soft, lightly crosslinked urethane layer with biocide additives is covered with a hard urethane layer that contains dissolvable particles. When the dissolvable particles are removed, the outer coating forms a semipermeable coating that allows slow diffusion of the underlying biocidal additive.

Layers of strongly-bonded polymer followed by weakly-bonded polymer. A silane treatment for silica compatabilization can be applied to the sand proppant outer surface. This treatment is followed by coating with an inner polymer layer containing functional additives, such as Fe₂O₃ particulates to provide sulfide scavenging. The outer layer coating contains polyacrylamides that are loosely bonded to the first coating. Once downhole, the polyacrylamide is released and collects on the internal surfaces of metal pipes in the well. This formulation can deliver friction reduction in the short term and offer a level of sulfide control over the lifetime of the well until the iron oxide particles were fully exhausted.

Staged Release Coatings.

Layered coatings can also be made with different functionality in different layers, with the intent that the outer layers could deliver functionality(ies) soon after introduction into a fracture, while the inner layers would be exposed later in the well cycle after the outer layers had eroded, or as the chemical additives in the inner layer diffused out over time. For example, oxygen related corrosion and asphaltene often are more problematic at the beginning of a well life cycle, while bacterial growth occurs later in the well life cycle. A composite coating of three layers can address such delayed developments. The first, innermost, layer can comprise, for example, a biocidal functionality. The second coating layer can comprise, for example, an asphaltene inhibitor, and the third layer can comprise, for example, a loosely bound polyhydroxyl compound as an oxygen scavenger. The outer layer of this proppant can reduce oxygen levels immediately, especially in dead zones/zones of limited flow from the entrance of the well, which can't be flushed with fluids containing oxygen scavengers. As the well begins production, the outer layer can be consumed and erode from the surface to expose the asphaltene-inhibiting layer of a sulfonated alkylphenol polymer that can also erode or dissolve over time. As the well continues to produce, asphaltene issues can lessen, and the remaining innermost coating can slowly release its biocides to ensure continued health of the well. A single, composite provides these extended benefits with less cost and easier logistics than the use of multiple proppants with different functions introduced into the well as a mixture.

Timed Release Coatings.

The use of an outer layer made with dissolvable particles and/or dissolvable or erodible polymers can be used to provide a controlled, timed release of functional additives much like an enteric coating of a medicament. Unlike a staged release structure, a timed release coating does not have a second stage of release. Importantly, the coated proppants according to the present disclosure provide for release over time, in situ, and throughout the fractured strata. Exemplary functional additives can include biocides, scale inhibitors, tracers, and sulfide control agents. Suitable water soluble and dissolvable polymers are described in U.S. Pat. No. 7,678,872. Erodible matrix materials include one or more cellulose derivatives, crystalline or noncrystalline forms that are either soluble or insoluble in water.

The time frame for release of an encapsulated ingredient via diffusion can be adjusted and tailored to the need by adjusting the cross-link density of the encapsulating coating. A polymer with little to no cross-linking exhibits a fast-dissolving coating for a short interval before release. Highly cross-linked materials can have a much slower rate of release of soluble ingredients in the coating. If mobility of the chemicals of interest is too low in a crosslinked membrane, dissolvable fillers like salts, organic crystalline solids, etc. can be incorporated in the coating mixture. Once the coated proppant is introduced downhole, the particles can dissolve to leave larger pores, as has been done with filtration membranes as in U.S. Pat. No. 4,177,228. If lightly cross-linked or a hydrogel, the polymer swells and will allow a controlled diffusion of the encapsulated additives.

Insoluble polymers, such as the thermosets (e.g., alkyds, partially-cured acrylics, phenolics, and epoxies) and the thermoplastics (e.g., polysulfones, polyethers, and polyurethanes) can be used as thin coatings with dissolvable additives. Such coatings are prepared by mixing, e.g., a thermoset polymer with finely divided, dissolvable solids and applying the resulting mixture to the proppant particles. Thermoplastics can be applied by dissolving the thermoplastic polymer in a solvent, mixing in the finely divided, dissolvable solids, and coating the proppants with the mixture. The solvent is then removed with a drying stage, which may be no more than a cross-flowing air stream. The time before release can be adjusted based on the size, shape, and solids concentration.

In some embodiments, the processes described herein provide for the formation of a self-polishing coating that dissolves over time or is eroded as fluid passes over the surface of the coating. Suitable materials for such coatings include acrylate copolymers with hydrolysable silylacrylate functional groups. (See U.S. Pat. No. 6,767,978). Alkyds, which are polyesters, can also be used as they tend to hydrolyze over time under downhole conditions and thereby impart a delayed-release mechanism through combination of hydrolysis and erosion.

Cellulosic coatings can also provide a timed release coating. Suitable and include, but are not limited to, the hydroxyalkyl cellulose family such as hydroxyethyl methylcellulose and hydroxypropyl methylcellulose (also known as hypromellose). A suitable material is commercially available under the tradename METHOCEL from Dow Chemical. This material is a cellulose ether made from water-soluble methylcellulose and hydroxypropyl methylcellulose polymers. Rheological modification can also be provided from the use of a hydroxyethyl cellulose agent, such as those commercially available under the tradename CELLOSIZE, from Dow Chemical.

Polyamides, which can be hydrolyzed under downhole conditions, can be used as well.

Acid/Base-Resistant Coatings.

Chemical attack of a proppant is a concern in hydraulic fracturing. For silica sand, the acid number of a proppant is often used to designate the sand's quality. The test in ISO 13503-2, section 8 describes the specific testing of proppant sand under acid exposure as a way to determine its suitability for specific well conditions. If components or impurities in the sand dissolve or are unstable in acidic environments, the proppant grains will gain porosity and exhibit a lower overall crush resistance. It can, therefore, be desirable to have a coating that could minimize the attack on the silica sand by acids found in downhole groundwaters. Acid resistance can be also be important, because, in some embodiments, acids can be pumped into a well to treat a production blockage. Therefore, in some embodiments, the acid resistance coating is used to avoid weakening the proppant that had been placed into the fracture when acid solutions (e.g. high concentrations of hydrochloric acid and/or a combination of hydrochloric-hydrofluoric acids).

Basic solutions can also dissolve or partially degrade silica proppants and the resin coating on such proppants, especially at a pH of nine or higher. This can cause issues in conductivities of proppant packs placed in fractures, due to weakening of the grains and possible reduction in particle size due to dissolving of outer layer of the particles.

Ceramic proppants can also suffer under highly basic or acidic waters as a result of diagenesis, a phenomenon in which the ceramic dissolves in aqueous solutions under pressure followed by a re-precipitation with other elements present in the fluid. The re-formed solid is unlikely to be as strong or the same size as the original ceramic proppant and can be a significant concern for its effects on conductivity of a ceramic proppant pack.

In some embodiments, the coatings that are applied are acid resistant, base resistant, or both, and can offer new protections for proppants of all types, including, but not limited to, sand and ceramic proppants. Some of the acid-resistant polymers that can be applied include: polypropylene, acrylic polymers, and most fluoropolymers. For increased coverage of the total exterior surface of the proppants, multiple coating applications of the same base polymer might be needed, depending on the equipment and number of dispersion nozzles that are used. The processes described herein can be repeated until the appropriate number of coatings are applied.

Suitable base-resistant polymers include the polyolefins, some fluoropolymers (except that PVDF and FKM are not particularly resistant to strong bases) and many polyurethanes.

Corrosion Inhibitors.

Corrosion of metals in downhole applications is a significant problem in the oil and gas industry. Corrosion can occur via either an acid-induced process or via oxidation. Acidic conditions can be caused by acid treatment of the formation, acid or H₂S producing bacteria, or CO₂ that can dissolve in water under pressure to form carbonic acid. Oxidation/oxidative corrosion of the metal can occur in the presence of water and oxygen.

Corrosion in downhole applications is often addressed by addition of corrosion inhibitors and/or acid scavengers during drilling, completion, or hydraulic fracturing. The corrosion inhibitor provides a coating to passivate the metal surfaces exposed to the fluids. Passivating layers of small molecules are also applied via addition of these molecules in a treating fluid, followed by use of complexation chemistry to attach the molecules to the metal, e.g., the use of active ligand sites on small organic molecules or polymers to bind to the metal. Acid scavengers are acid-accepting and basic compounds. Periodic washing or flushing with fluids containing such materials after the initial treatment is also a common method to keep corrosion under control.

Oxygen scavengers are used to remove dissolved oxygen from downhole fluids. Once a well is completed, oxygen is not usually a significant problem as it is not normally present in producing formations, but it can be a problem in drilling muds and fracture fluids. Oxygen scavengers are used in these fluids during drilling, fracturing or completion.

Polymeric coatings for the metallic surfaces to prevent corrosion are often used, and applied to the metals prior to their use. Baked resins, or epoxy coatings, are two examples, but other polymers can be used on the metals. Cathodic protection is also used where possible, by placing a more reactive metal near the metal to be protected, and using the more reactive metal to react or oxidize with the chemistries in the fluid, rather than the metals which are desired to be protected. Zinc, aluminum and other metals which are more reactive than iron (Fe) are used for cathodic protection.

Chemicals that can be applied to the solids for corrosion protection include 1-benzylquinolinium chloride (CAS 15619-48-4), acetaldehyde (CAS 57-07-0), ammonium bisulfite (CAS 10192-30-0), benzylideneacetaldehyde (CAS 104-55-2), castor oil (CAS 8001-79-4), copper chloride anhydrous (CAS 7447-39-4), fatty acid esters (CAS 67701-32-0), formamide (CAS 75-12-7), octoxynol 9 (CAS 68412-54-4), potassium acetate (CAS 127-08-2), propargyl alcohol (CAS 107-19-7), propylene glycol butyl ether (CAS 15821-83-7), pyridinium, 1-(phenylmethyl)-(CAS 68909-18-2), tall oil fatty acids (CAS 61790-12-3), tar bases, quinoline derivatives, benzyl chloride-quaternized (CAS 72480-70-7), and triethylphosphate (CAS 78-40-0), or any combination thereof.

Corrosion inhibitors that are solids can be mixed into resin formulations as a filler, then applied to proppants to form a coating that can deliver the corrosion protection directly downhole. The coatings can be designed to deliver corrosion protection immediately, as might be desired for oxygen scavengers during drilling or completion. The coatings can also be tailored for timed release of corrosion, as discussed above. Cathodic protection can be provided by also including one or more metal particles (Zn, Al, Mg, and the like) in highly conductive produced waters/brines. These can, in some embodiments, act as an electrolytic solution to allow electron transfer to enable the cathodic protection.

Corrosion inhibitors that are liquids can be introduced into these systems via selection of a polymer proppant coating in which the liquids/organic chemicals are miscible or semi-soluble. Some examples include digycolamines mixed with polyacrylamides, or lightly crosslinked or thermoplastic polyurethanes.

Other polymers, such as 2-vinyl-2-oxyzoline can be used as water soluble polymer fillers that can be encapsulated in a resin coating on proppant particles, and dissolved over time from the coating. The soluble molecules can then passivate metal surfaces, and inhibit acidic corrosion.

Acid scavenging activity can be provided with a flash coating of polymers having acid scavenging attributes. For example, polymers with nitrogen containing heteroatoms such as polyvinylpyridine and polyvinylpyrrolidone, carboxylates, or pendant amines can provide such acid scavenging activity, i.e., nitrogen can interact with acids to form a salt. The scavenging power of these polymers can be related to the concentration of functional groups on the polymer as well as the mobility and accessibility of these groups to react with the produced fluids and remove acidic impurities.

Improvement in Crush Resistance.

Water-based dispersions of precured polyurethanes can be mixed with a polyurethane crosslinking agent such as polyaziridine, isocyanate or carbodiimides to generate a hard, cross-linked, coating in low concentration. Variations of the nature and amount of the crosslinking agent, as exists for one of no more than an ordinary level of skill in this art, allow the cure levels of the coating to be adjusted and tailored for more or less hardness, crosslink density, glass transition temperature, and permeation rate. In some embodiments, coating levels per treatment of up to 0.5% or 0.1-0.5 wt % based on the weight of the proppant can be applied. In some embodiments, the coatings in total are up to about 4 wt % based on the weight of the proppant. In some embodiments, the coatings in total about 1-4 wt % based on the weight of the proppant. In some embodiments, multiple coatings are applied to generate thicker coatings, if desired. In some embodiments, polyurethane can be used to increase crush resistance, see, for example, Example 3. Other types of thermoplastic and thermoset polymeric coatings should exhibit similar results.

Paraffin Inhibitors.

Paraffins are long chain hydrocarbons, typically C₁₈ to C₁₀₀ or more (18-100 carbons) that often precipitate out of a hydrocarbon solution due to changes in temperature or composition that decrease the solubility of the paraffin in the hydrocarbon fluids. Once precipitated, those paraffins can crystallize to form a waxy buildup.

In some embodiments, paraffin inhibitors can be coated into or onto proppants. Such a coating places the treatment in the fractured strata and at the elevated temperatures found downhole before the paraffins have begun to precipitate or crystallize. By introducing the inhibitors in the fractured strata while the paraffins are still soluble, the treatment can affect the crystallization rate of paraffin as the produced hydrocarbon stream cools and/or mixes with water as it moves towards the surface and consolidates with other frac streams for recovery. Such conditions often result in reduced paraffin solubility and create conditions where paraffin precipitation and crystallization become problematic.

The paraffin inhibitors of the present disclosure can be added as a polymeric coating on the proppants or as released additives. The coated polymers can stay associated with the proppant particles until the proppant was exposed to hydrocarbons whereupon the polymers can dissolve in the hydrocarbon or mixed hydrocarbon/water effluent. Releasable additives contained in timed release or staged release coatings of the types discussed above allow the paraffin inhibitor additives to be released over time via diffusion out of the swelled or dissolving coating or by migration out of a coating whose soluble particulates had left openings for egress of the paraffin additives.

Polymers that can serve as paraffin inhibitors include, e.g., styrene ester copolymers and terpolymers, esters, novalacs, polyalkylated phenol, and fumerate-vinyl acetate copolymers. Tailoring the molecular weight of the inhibitor as well as the lengths of the pendant chains can be used to modify the nature of the inhibition effects. These characteristics affect both the crystallization rate and size distribution of paraffin crystals and thus the pour point of the resulting solutions.

Paraffin pour point can be decreased by adding solvents to a hydrocarbon mixture to increase solubility of paraffin, and thus reduce the crystallization rate and overall crystallite size distribution of the paraffin crystals. These are often copolymers of acrylic esters with allyl ethers, urea and its derivatives, ethylene-vinlyacetate backbone with unsaturated dicarboxylic acid imides, dicarboxylic acid amides, and dicarboxylic acid half amides.

Polymers that are useful for paraffin crystal modification include ethylene-vinyl acetate copolymers, acrylate polymers/copolymers, and maleic anhydride copolymers and esters.

Paraffin dispersants work via changing the paraffin crystal surface, causing repulsion of the paraffin particles and thus inhibit formation of larger paraffin agglomerates that could precipitate from suspension in the reservoir fluids. Typical chemistries include olefin sulphonates, polyalkoxylates and amine ethoxylates.

Hydrate Inhibitors or Hydrate Agglomerate Inhibitors

Gas Hydrate formation in petroleum production is a common problem in cold, high pressure conditions where gas and water may coexist. In a formation under high pressure and/or temperature the gases and water may exist as 2 phase systems. As pressure is lowered and the produced hydrocarbon/water mixture leaves the formation and cools, hydrates are more likely to become a problem. Hydrates are a major issue pipelines but this problem can also be found in the well itself, particularly during shut in. As temperature is lowered or pressure is increased, hydrates may form, especially close to the surface in offshore wells where the water temperature is approximately 4 C. (Textbook, “Oilfield Chemicals”, Johannes Karl Fink p 177-182), which is hereby incorporated by reference.

Hydrate formation or hydrate agglomeration can also happen in wells where liquid, gas, and water are all produced simultaneously. Drying the gas is one solution for pipelines, and specifications are <200 ppm water for gas transport, but this is not an efficient solution. For example, while the gas/water mixture is still in a formation, it is not practical to dry it by traditional methods. Antifreeze agents such as propylene glycol or alcohols, such as methanol, can also be used to reduce the freezing point and reduce the likelihood of hydrate formation, but these can be costly ingredients and act mainly on the solution as a whole so require large quantities of chemicals to perform adequately. Therefore, an alternative solution, which is surprising, is the use of a coating that acts as hydrate inhibitors. Without being bound to any particular theory, these coatings act on the principle of disruption of crystallization processes, either through changes in crystallization rate or through changes in growth rate of crystals. Hydrate anti-agglomerates work through inhibiting agglomeration of smaller crystals into larger masses that can block or impede flow of gas or hydrocarbons.

Accordingly, a coating comprising a hydrate inhibitor or a compound that can act as a hydrate anti-agglomerate is provided. In some embodiments, the coating comprises alkylated ammonium compound, an alkylated phosphonium compound, an alkylated sulfonium compound, or any combination thereof. In some embodiments, the coating comprises tetrabutylammonium bromide. Water soluble polymers or copolymers of acrylamide, n-vinylamide maleimide, vinyllactam maleamide, alkenyl cyclic imino ether maleimide or other such polymers can also be used. Examples of hydrate anti-agglomerates include, but are not limited to, a coating comprising dodecyl-2-(2-caprolactamyl) ethanamide.

These additives that inhibit hydrate formation or act as hydrate anti-agglomerates can be mixed with a polymer and attached to proppants, for example as described herein, for targeted delivery deep into a fracture. The chemicals can be applied, for example, as a single layer, and the polymer might be applied on top to contain the chemical/active polymer. The permeability of the polymer can be modified to allow a timed release of the chemicals/inhibitory polymers. A mixture of polymer/active components might also be used for a more immediate delivery. In some embodiments, dissolvable or degradable polymers can be used to tailor the dosing time for the chemicals. A fast dissolving coating would allow for a quick delivery, slow dissolving could allow for timed release over a longer period of time.

Clay Stabilizers.

Clays are layered particles of silicon and aluminum oxide. Any disruption in the charge balance between aluminum and oxygen creates negatively charged particles. When cations from solution surround the clay particle, they create positively charged particles. Such particles resist each other and are likely to migrate. The dispersed particles can block pore spaces in the rock or into proppant pack and reduce permeability. Accordingly, coatings can be used to reduce the formation of clay particles that can negatively affect the proppant pack. Previously, solutions containing 1% to 3% Potassium Chloride (KCl) were used in fracturing fluids as temporary clay stabilizer clays. In addition to KCl, many salts can be used in the fracturing fluid as granular salt or liquid such as the organic cation tetramethyl ammonium chloride, Sodium Chloride (NaCl), Calcium Chloride (CaCl₂), and Ammonium Chloride (NH₄Cl). All these salts help maintain the chemical environment of the clay particles, but they do not provide permanent protection and lead to long term problems. So called permanent methods have used quaternary amines or inorganic polynuclear cations, but these chemicals have limited compatibility with higher pH fracturing fluids.

To overcome these issues, in some embodiments, coating a proppant with a cationic polymer/surfactant, and optionally associated with time release mechanism, can provide more effective clay stabilizing especially for the under-saturated shale formations which may help to reduce the production decline in these tight-permeability formations. The compound in the coating, can for example, act as a clay stabilizer when it is released from the coating into the formation. In some embodiments, the cationic surfactant is based upon quaternary ammonium salt. In some embodiments, the salt can be of the formula LX⁻, wherein LX⁻ is a short alkyl chain link to a strong acid salt such as sulfonate (from sulfonic acid). Some examples include, but are not limited to, R(R^{a})₃N+XSO⁻₃, wherein R is a long-chain alkyl group, R^{a} is a short chain alkyl, and X is a linking carbon (e.g. 1-4 carbons). In some embodiments, the long-chain is C₈-C₁₆ alkyl. In some embodiments, the short chain alkyl is C₁-C₆. In some embodiments, other quaternary ammonium compounds (e.g. salts) can be used. Quaternary amine surfactants can also be used if pH of the solution is acidic. Some examples of quaternary compounds are, but not limited to, monoalkyltrimethylammonium salts, dialkyldimethylammonium salts, trialkylmethyl ammonium salts or tetraalkylmethylammonium salts. The products Ethoquad™, Duoquad™, and Ethoquad™ from AkzoNobel are some non-limiting examples that can be used. In some embodiments, pyridinium salts may also be used. An example of such a salt includes, but is not limited to, cetylpyridinium chloride. Other examples are described in Madaan and Tyagi, “Quaternary Pryidinium Salts: A Review,” Journal of Oleo Science, 57(4) 197-215 (2008), which is incorporated by reference in its entirety. In some embodiments, other nitrogen containing heterocyclic cationic surfactants, such as, but not limited to, imadizolinium salts can be used.

Surfactants can also be used as described herein. Additionally, a surfactant can be added to fracturing fluids at low concentration to lower the surface tension and/or the interfacial tension when adsorbed at the interface between two immiscible materials such a such as oil and water, a liquid and a gas, or a liquid and a solid. Different surfactants can be used in fracturing fluids for different purposes. They can be necessary in foam treatments to promote the formation of stable bubbles or can be used with polyemulsion fluids to stabilize the oil-in-water emulsion. Furthermore, they can be used as surface-tension-reducing agents and formation-conditioning agents to promote cleanup of the fracturing fluid from the fracture. Also, some bactericides and clay-control agents are surfactants. However, these surfactants are not part of the proppant pack.

In formations with multiphase flow (i.e., oil and water), the water production increases overtime and the oil production decreases. Long-term, time-released surfactants or co-surfactants, coated on the proppant, can be used, for example, to create micro-emulsions at the interface between crude oil and water, thus generating advantageous environment for mobilization of residual oil and result in improved oil recovery. In situations where the formation fluid is mainly oil, surfactants can be used to lower the surface tension between oil and proppant to increase oil mobility.

Cationic chemistries similar to those listed for clay stabilizers can be used. Since the surface of silicates can be negatively charged, especially in contact with water, cationic surfactants and polymers will have a strong electrostatic attraction to the silica surfaces. If the pH of the water produced by the formation is near neutral or acidic, quaternary amine surfactants can also be used. In some embodiments, the quaternary ammonium surfactants will be protonated and thus in cationic form.

In some embodiments, nonionic surfactants can be used. For example, alkoxylated alcohols with longer alkyl groups (e.g., C₁₀-C₁₈) can associate with the silica surface through the polar end of the surfactant molecules, but present a hydrophobic end to the fluid media flowing through the pore space between particles.

In some embodiments, if delivery of surfactants from the proppant is desired (for example, to perform a demulsification in situ), lower levels of ethoxylation can be used so the surfactant can migrate from the proppant surface into the flowing hydrocarbon fluid. In some embodiments, the proppant can be coated with a surfactant and a time-release surface polymer coating can be used to allow the surfactant to be exposed to the fluid over time.

The clay stabilizer(s) and/or surfactants can be incorporated into the coatings that are coated onto the proppants as described herein and by any method. Additionally, as described herein, the clay stabilizer and/or surfactants can be coated onto a proppant and then an additional layer is coated on top of the clay stabilizer and/or surfactants that allows for an extended release or immediate release of the clay stabilizer and/or surfactants once the proppants are down hole.

Asphaltene Inhibitors.

Asphaltenes are complex polycyclic aromatic compounds, often with heteroatoms and with aliphatic side chains. They are present in many hydrocarbon reserves at concentrations that vary from <1 to 20%. They are soluble in benzene or aromatic solvents but insoluble in low molecular weight alkanes.

Asphaltenes pose similar issues to the paraffins in that they are typically soluble in the pressurized, heated hydrocarbon mixture in a reservoir field, but changes in temperature and pressure during production from that reservoir can cause precipitation or flocculation. Either of these can have the effect of reducing fluid flow or, in the worst case, stopping fluid flow completely. Once the asphaltenes precipitate, the well must be remediated by mechanically scraping or dislodging the deposits through the application of differential pressures or by cleaning with toluene, xylene, or other suitable aromatic solvent. Cleaning is expensive and stops well production during the process so the asphaltene additives carried by treated proppants represent a substantial economic benefit for well owners and operators.

Asphaltene is controlled via use of dispersing additives or inhibitors. Dispersants reduce the particle size of the precipitated asphaltenes and keep them in suspension. Dispersants are often used as frac fluid additives at a point after asphaltene precipitation is likely to occur, i.e., after a pressure drop or temperature drop as the oil moves from the reservoir into the production channels. Dispersants are usually nonpolymeric surfactants. Some asphaltene dispersants that have been used in frac fluids include: very low polarity alkylaromatics; alklarylsulfonic acids; phosphoric esters and phosphonocarboxylic acids; sarcosinates; amphoteric surfactants; ethercarboxlic acids; aminoalkylene carboxylic acids; alkylphenols and their ethoxylates; imidazolines and alkylamine imidazolines; alkylsuccinimides; alkylpyrrolidones; fatty acid amides and their ethoxylates; fatty esters of polyhydric alcohols; ion-pair salts of imines and organic acids; and ionic liquids.

Inhibitors actually prevent the aggregation of asphaltene molecules and prevent precipitation. Asphaltene inhibitors are typically polymers. Common asphaltene inhibitors that have typically been used in frac fluids include: alkylphenol/aldehyde resins and sulfonated variants of these resins; polyolefin esters, amides, or imides with alkyl, alkylene phenyl, or alkylene pyridyl functional groups; alkenyl/vinylpyrolidone copolymers; graft polymers of polyolefins with maleic anhydride or vinylimidazole; hyperbranched polyesterimides; lignosulfonates; and polyalkoxylated asphaltenes.

Polymeric asphaltene inhibitors can be introduced directly as coatings on the proppant particles. They can be applied as coatings that can be released in a controlled fashion either immediately or slowly over time by the timed release and staged release coatings discussed above.

The asphaltene inhibitors can also be used as an additive in a polymeric coating.

Asphaltene dispersants can be used mainly as ingredients/fillers in a coating to be released over time. Their release over time can be controlled with the coatings discussed herein depending on whether an immediate release or timed release dosing is desired. Branched polymers with arms that contain the dispersant functionality can also be used where the branches are connected to the polymer backbone by reactive groups that might degrade over time, such as esters, hydrolysable groups, and the like to release the dispersants over time.

An advantage of using asphaltene control agents directly on proppant particles is that these agents can be released within the formation prior to asphaltene precipitation. Such an in-situ delivery allows effective treatment before development of the problem and in controlled concentrations.

Fines Migration Control.

In addition to higher crush resistance and decreased equipment wear from handling, flash coatings of the present disclosure can help control fines migration downhole and thereby help to maintain conductivity.

Fines produced through crushing of the proppant pack can fill a portion of the interparticle porosity, which is directly linked to conductivity. More importantly fines can be mobilized under pressure in downhole conditions during fluid production to cause a great amount of damage, sometimes more than a 75% reduction in conductivity.

The effect of fines migration is not obvious in a standard conductivity test, as the test is performed at too low of a flow rate to mobilize fines. Some control over fines migration downhole can be added to proppants by applying to the treated proppants an external tackifier that will capture fines encountered downhole. The coated proppants are then placed in the well during fracturing. This ensures the fines control treatment is accurately placed on the surface of the particles and ensures that the coating penetrates the fracture as deeply as the proppant particles.

Common tackifier resins or resin dispersions that can be used for fines control on a proppant include: a) rosin resins from aged tree stumps (wood rosin), sap (gum rosin), or by-products of the paper making process (tall oil rosin); b) hydrocarbon resins from petroleum based feedstocks either aliphatic (C5), aromatic (C9), dicyclopentadiene, or mixtures of these; and c) terpene resins from wood sources or from citrus fruit. Other coatings described herein can also be used to reduce fines migration after the well is put back into production.

Removal of Anions/Halogens from Produced Water.

Halogens, particularly bromines, can cause issues in produced water due to the reaction with disinfectants to make disinfection by-product compounds. For bromide, a concentration value of 0.1 mg/L poses a risk for unintended by-product production. These by-products can also be potential carcinogens. For example, some by-product compounds have toxicologic characteristics of human carcinogens, four which are already regulated, e.g., bromodichloromethane, dichloroacetic acid, dibromoacetic acid, and bromate.

The removal of bromines can occur in the context of the present disclosure by adding anion exchange resins into or onto a resin coating on a proppant. Such exchange resins can be added during application of a flash coating as described herein or at the end thereof as the coating dries for adhesive-type incorporation into the coated surface.

The processes and compositions described herein are well-suited to the treatment of a variety of proppant solids in a context other than a formal resin-coating operation or facility. As such, the process can be used to apply, for example, a dust suppressing, liquid treatment agent as an uncured coating over at least a portion, such as a large portion, of the proppant solids within the bulk mixture. Such a treatment process affords the possibility that the process can be used to provide the proppant solids with additional properties without the need for a formal, manufacturing facility-based coating process. Such types of additional functionalities are described in U.S. Pat. No. 8,763,700, the disclosure of which is hereby incorporated by reference. Such additional materials can include, e.g., pigments, tints, dyes, and fillers in an amount to provide visible coloration in the coatings. Other materials can include, but are not limited to, reaction enhancers or catalysts, crosslinking agents, optical brighteners, propylene carbonates, coloring agents, fluorescent agents, whitening agents, UV absorbers, hindered amine light stabilizers, defoaming agents, processing aids, mica, talc, nano-fillers, impact modifiers, and lubricants. Other additives can also include, for example, solvents, softeners, surface-active agents, molecular sieves for removing the reaction water, thinners and/or adhesion agents can be used. The additives can be present in an amount of about 15 weight percent or less. In one embodiment, the additive is present in an amount of about 0.005-5 percent by weight of the coating composition. The processes described herein can also be used to add other functionalities as described herein.

The proppants described herein can be used in a gas or oil well. For example, the proppants can be used in a fractured subterranean stratum to prop open the fractures as well as use the properties of the proppant in the process of producing the oil and/or gas from the well. In some embodiments, the proppants are contacted with the fractured subterranean stratum. The proppants can be contacted with the fractured subterranean stratum using any traditional methods for introducing proppants and/or sand into a gas/oil well. In some embodiments, a method of introducing a proppant into a gas and/or oil well is provided. In some embodiments, the method comprises placing the proppants into the well.

Proppant solids can be virtually any small solid or porous substance with an adequate crush resistance and lack of chemical reactivity. Suitable examples include, but are not limited to, sand, high strength polymeric resins, polymeric composites with reinforcing fillers, and ceramic particles (such as aluminum oxide, silicon dioxide, titanium dioxide, zinc oxide, zirconium dioxide, cerium dioxide, manganese dioxide, iron oxide, calcium oxide or bauxite) that may or may not embody the treatment agent component as an integral component of the ceramic matrix or structure, or also other granular materials. Proppant materials that have been widely used include, for example, (1) particulate sintered ceramics, such as aluminum oxide, silica, or bauxite, often with clay-like binders or other additives to increase the particulate's compressive strength, especially sintered bauxite; (2) natural, relatively coarse, sand, the particles of which are roughly spherical, generally called “frac sand”; (3) resin-coated particulates of the sintered ceramics and/or sand; and (4) composite particles or composite particles containing a solid or porous solid core in which the treatment agent is an integral part of the solid core or disposed within pores of the porous solid core. In some embodiments, the proppants to be coated have an average particle size from about 50 μm and about 3000 μm, or from about 100 μm to about 2000 μm.

In some embodiments, the proppant has a distribution of particles having sizes in the range of from about 4 mesh to about 100 mesh (U.S. Standard Sieve numbers), i.e., the particles pass through a screen opening of about 4760 microns (4 mesh) and are retained on a screen opening of about 150 microns (100 mesh). In some embodiments, the proppants have a distribution of particle sizes in which 90% are from about 8 mesh to 100 mesh. In some embodiments, the proppants have a distribution of particle sizes in which 90% are from about 16 mesh to 70 mesh. In some embodiments, the proppants have a distribution of particle sizes with at least 90% by weight of the particles having a size within a desired range, such as the range of 20 mesh to 40 mesh, i.e., between about 850 and about 425 microns.

### Coatings

A coating can be used to provide exposed surface moieties of the types noted above that have an affinity for removing contaminants or the coating can be used as an insoluble binder to secure or adhere a particulate treatment agent component to the outer surface of the proppant solid. Coatings can be cured, partially cured or uncured and are intended to secure the treatment agent component to the proppant solid. Which of these forms is most desirable for a particular well will depend on the coating, its dissolution characteristics in the downhole environment, and the nature of the treatment agent. One of skill in the art can determine the time type of coating based upon the present disclosure.

Coatings used to bind the treatment agent and the proppant solid can use virtually any coating formulation. In some embodiments, the coating formulations that are used help consolidate or improve the strength of the proppant within the fractured stratum and resist washout. For example, thermoset and thermoplastic resins can be used. In some embodiments, hot melt adhesives can be used for the coating on the proppant because it will exhibit a latent tackiness, i.e., the tackiness of the coating does not develop until the proppant is placed into the hydrocarbon-bearing formation. Within the downhole environment, the subterranean heat causes the adhesive to become tacky so that aggregation occurs as the coating softens to cause the tacky adhesive thermoplastic to produce stable agglomerates within the fractured subterranean formation.

In some embodiments, resin coated proppants can be described as three types: precured, partially cured, and curable. Precured resin coated proppants comprise a substrate coated with a resin which has been significantly crosslinked. The resin coating of the precured proppants provides crush resistance to the substrate. Since the resin coating is already cured before it is introduced into the well, even under high pressure and temperature conditions, the proppant does not agglomerate and is capable of generating substantial particle to particle bond strength. Such precured resin coated proppants are typically held in the fracture by the stress surrounding them. The resin coating of a partially cured proppant has been partially reacted during the manufacturing process but retains a significant level of curability. The resin coating of the curable proppants is not significantly crosslinked or cured before injection into the oil or gas well. The partially cured and curable coatings are designed to crosslink under the stress and temperature conditions existing in the well formation. This causes the proppant particles to bond together forming a 3-dimensional matrix and preventing proppant flow-back.

In some embodiments, one type of the suitable coating is 0.1-10 wt % of a cured, partially cured or curable organic polymer, prepolymer, and oligomer of resole or novolac type. The specific chemistries of such organic coatings can be chosen from a wide selection, including epoxy, phenolic, polyurethane, polycarbodiimide, furan resins and combinations of these with each other. The phenolics of the above-mentioned novolac or resole polymers may be phenol moieties or bis-phenol moieties. In some embodiments, the resin is a novolac resin. Examples of thermoplastics include, but are not limited to, polyethylene, acrylonitrile-butadiene styrene, polystyrene, polyvinyl chloride, fluoroplastics, polysulfide, polypropylene, styrene acrylonitrile, nylon, and phenylene oxide. Examples of thermosets include, but are not limited to, epoxy, phenolic, e.g., resole (a true thermosetting resin) or novolac (thermoplastic resin which is rendered thermosetting by a hardening agent), polyester resin, polyurethanes and derivatives thereof, and epoxy-modified novolac. The phenolic resin comprises any of a phenolic novolac polymer; a phenolic resole polymer; a combination of a phenolic novolac polymer and a phenolic resole polymer; a cured combination of phenolic/furan resin or a furan resin to form a precured resin.

In some embodiments the proppant coating is a polyurethane coating that includes a substantially homogeneous mixture that comprises: (a) an isocyanate reactant, and (b) a polyol reactant which exhibits a polyol functionality of 2-4. In some embodiments, the isocyanate component is used in a slight excess, e.g., 1-15 wt % excess.

In some embodiments, the coating process applies one or more layers of cured or substantially cured polyurethane around a solid proppant core. The coating is cured and crosslinked to the point that it can resist dissolution under the rigorous combination of high heat, agitation, abrasion and water found downhole in a well. In some embodiments, the substantially cured coating exhibits a sufficient resistance to a 10 day autoclave test or 10 day conductivity test so that the coating resists loss by dissolution in hot water (“LOI loss”) of less than 25 wt %, less than 15 wt %, or a loss of less than 5 wt %. In some embodiments, the substantially cured coating resists dissolution in the fractured stratum while also exhibiting sufficient resistance to flow back and sufficiently high crush resistance to maintain conductivity of the fractures.

A method for evaluating proppants is described in ISO 13503-5:2006(E) “Procedures for measuring the long term conductivity of proppants”, the disclosure of which is herein incorporated by reference. ISO 13503-5:2006 provides standard testing procedures for evaluating proppants used in hydraulic fracturing and gravel packing operations. ISO 13503-5:2006 provides a consistent methodology for testing performed on hydraulic fracturing and/or gravel packing proppants. The “proppants” mentioned henceforth in this part of ISO 13503-5:2006 refer to sand, ceramic media, resin-coated proppants, gravel packing media, and other materials used for hydraulic fracturing and gravel-packing operations. ISO 13503-5:2006 is not applicable for use in obtaining absolute values of proppant pack conductivities under downhole reservoir conditions, but it does serve as a consistent method by which such downhole conditions can be simulated and performance properties of proppant compared in a laboratory setting.

In some embodiments, the isocyanate component of a coating comprises an isocyanate with at least 2 reactive isocyanate groups. Other isocyanate-containing compounds may also be used. Examples of suitable isocyanate with at least 2 isocyanate group include, but are not limited to, s an aliphatic or an aromatic isocyanate with at least 2 isocyanate groups (e.g. a diisocyanate, triisocyanate or tetraisocyanate), or an oligomer or a polymer thereof can be used. These isocyanates with at least 2 isocyanate groups can also be carbocyclic or heterocyclic and/or contain one or more heterocyclic groups.

In some embodiments, the isocyanate with at least 2 isocyanate groups is a compound of the formula (I) or a compound of the formula (II):

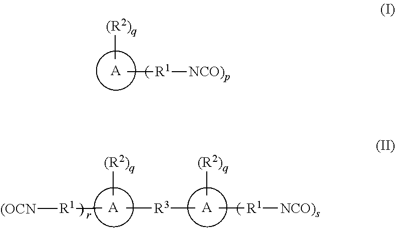

In some embodiments regarding the formulas (II) and (II), each A is, independently, an aryl, heteroaryl, cycloalkyl or heterocycloalkyl. In some embodiments, each A is, independently, an aryl or cycloalkyl. In some embodiments, each A is, independently, an aryl which is phenyl, naphthyl or anthracenyl. In some embodiments, A is a phenyl.

In some embodiments, the above mentioned heteroaryl is a heteroaryl with 5 or 6 ring atoms, of which 1, 2 or 3 ring atoms are each, independently, an oxygen, sulfur or nitrogen atom and the other ring atoms are carbon atoms. In some embodiments, the heteroaryl is selected among pyridinyl, thienyl, furyl, pyrrolyl, imidazolyl, pyrazolyl, pyrazinyl, pyrimidinyl, pyridazinyl, oxazolyl, isoxazolyl or furazanyl.

In some embodiments, the above mentioned cycloalkyl is a C₃₋₁₀-cycloalkyl or a C₅₋₇-cycloalkyl.

In some embodiments, heterocycloalkyl is a heterocycloalkyl with 3 to 10 ring atoms (e.g., 5 to 7 ring atoms), of which one or more (e.g., 1, 2 or 3) ring atoms are each, independently, an oxygen, sulfur or nitrogen atom and the other ring atoms are carbon atoms. In some embodiments, the heterocycloalkyl is selected from among tetrahydrofuranyl, piperidinyl, piperazinyl, aziridinyl, acetidinyl, pyrrolidinyl, imidazolidinyl, morpholinyl, pyrazolidinyl, tetrahydrothienyl, octahydroquinolinyl, octahydroisoquinolinyl, oxazolidinyl or isoxazolidinyl. In some embodiments, the heterocycloalkyl is selected from among tetrahydrofuranyl, piperidinyl, piperazinyl, pyrrolidinyl, imidazolidinyl, morpholinyl, pyrazolidinyl, tetrahydrothienyl, oxazolidinyl or isoxazolidinyl.

In the formulas (I) and (II), each R¹ is, independently, a covalent bond or C₁₋₄-alkylene (e.g. methylene, ethylene, propylene or butylene).

In the formulas (I) and (II), each R² is each, independently, a halogen (e.g. F, Cl, Br or I), a C₁₋₄-alkyl (e.g. methyl, ethyl, propyl or butyl) or C₁₋₄-alkyoxy (e.g. methoxy, ethoxy, propoxy or butoxy). In some embodiments, each R² is, independently, a C₁₋₄-alkyl. In some embodiments, each R² is methyl.

In the formula (II), R³ is a covalent bond, a C₁₋₄-alkylene (e.g. methylene, ethylene, propylene or butylene) or a group —(CH₂)_{R31}—O—(CH₂)_{R32}—, wherein R31 and R32 are each, independently, 0, 1, 2 or 3. In some embodiments, R³ is a —CH₂— group or an —O— group.

In the formula (I), p is equal to 2, 3 or 4. In some embodiments, p is 2 or 3. In some embodiments, p is 2.

In the formulas (I) and (II), each q is, independently, an integer from 0 to 3. In some embodiments, each q is independently 0, 1 or 2. When q is equal to 0, the corresponding group A has no substituent R², but has hydrogen atoms instead of R².

In some embodiments of the formula (II), each r and s are, independently, 0, 1, 2, 3 or 4, wherein the sum of r and s is equal to 2, 3 or 4. In some embodiments, each r and s are, independently, 0, 1 or 2, wherein the sum of r and s is equal to 2. In some embodiments, r is equal to 1 and s is equal to 1.

Examples of the isocyanate with at least 2 isocyanate groups include, but are not limited to: toluol-2,4-diisocyanate; toluol-2,6-diisocyanate; 1,5-naphthalindiisocyanate; cumol-2,4-diisocyanate; 4-methoxy-1,3-phenyldiisocyanate; 4-chloro-1,3-phenyldiisocyanate; diphenylmethane-4,4-diisocyanate; diphenylmethane-2,4-diisocyanate; diphenylmethane-2,2-diisocyanate; 4-bromo-1,3-phenyldiisocyanate; 4-ethoxy-1,3-phenyl-diisocyanate; 2,4′-diisocyanate diphenylether; 5,6-dimethyl-1,3-phenyl-diisocyanate; 2,4-dimethyl-1,3-phenyldiisocyanate; 4,4-diisocyanato-diphenylether; 4,6-dimethyl-1,3-phenyldiisocyanate; 9,10-anthracene-diisocyanate; 2,4,6-toluol triisocyanate; 2,4,4′-triisocyanatodiphenylether; 1,4-tetramethylene diisocyanate; 1,6-hexamethylene diisocyanate; 1,10-decamethylene-diisocyanate; 1,3-cyclohexylene diisocyanate; 4,4′-methylene-bis-(cyclohexylisocyanate); xylol diisocyanate; 1-isocyanato-3-methyl-isocyanate-3,5,5-trimethylcyclohexane (isophorone diisocyanate); 1-3-bis(isocyanato-1-methylethyl)benzol (m-TMXDI); 1,4-bis(isocyanato-1-methylethyl)benzol (p-TMXDI); oligomers or polymers of the above mentioned isocyanate compounds; or mixtures of two or more of the above mentioned isocyanate compounds or oligomers or polymers thereof.

In some embodiments, the isocyanates with at least 2 isocyanate groups are toluol diisocyanate, diphenylmethane diisocyanate, an oligomer based on toluol diisocyanate or an oligomer based on diphenylmethane diisocyanate.

In some embodiments, the polyol is a trifunctional polyether polyol that is based on glycerine or trimethylol propane, either of these may, or may not, have been alkoxylated with ethylene oxide, propylene oxide and/or 1,2-butylene oxide. Such a coating, when properly formed, is a hard, glassy coating over substantially the entirety of the surface of the proppant core solid. The proppant coating is cured in that the coating is effectively immune to the effects of exposure to heat during storage and transport but develops substantial interparticle bond strengths like a partially cured coating when exposed to downhole conditions and crushing pressures from crack closure. Typical interparticle bond strengths are at least 100 psi in an unconfined compressive strength (UCS) test and more typically within the range of 250-1000 psi in UCS testing.

Another suitable polyol component for coating the proppant comprises a phenol resin that comprises a condensation product of a phenol and an aldehyde, such as formaldehyde. The phenol resin can be, for example, a resole or novolak phenol resin, or for example, a benzyl ether resin.

In some embodiments, the resole-type phenol resin can be obtained, for example, by condensation of phenol or of one or more compounds of the following formula (III), with aldehydes, such as formaldehyde, under basic conditions.

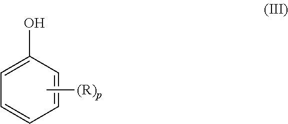

In the formula (III): “R” is in each case, independently, a hydrogen atom, a halogen atom, C₁₋₁₆-alkyl or —OH;

“p” is an integer from 0 to 4, 0, 1, 2 or 3, or 1 or 2. Those in the art will understand that when p is 0, the compound of formula (III) is phenol. In some embodiments of formula (III), “R” is C₁₋₁₂-alkyl, C₁₋₆-alkyl, methyl, ethyl, propyl or butyl.

Novolak-type phenol resin can be a condensation product of phenol or of one or more compounds of the formula (III) defined above, with aldehydes, such as formaldehyde, under acidic conditions.

In some embodiments, the phenol resin is a benzyl ether resin of the general formula (IV):

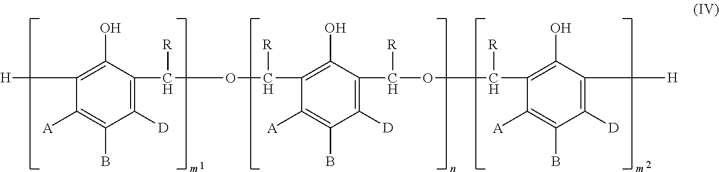

In the formula (IV): each A, B and D are, independently, a hydrogen atom, a halogen atom, a C₁₋₁₆-hydrocarbon residue, —(C₁₋₁₆-alkylene)-OH, —OH, an —O—(C₁₋₁₆-hydrocarbon residue), phenyl, —(C₁₋₆-alkylene)-phenyl, or —(C₁₋₆-alkylene)-phenylene-OH. In some embodiments, the halogen atom is F, Cl, Br or I. In some embodiments, the C₁₋₁₆-hydrocarbon-residue is C₁₋₁₆-alkyl, C₂₋₁₆-alkenyl or C₂₋₁₆-alkinyl, C₁₋₁₂-alkyl, or C₂₋₁₂-alkenyl. In some embodiments, the C₁₋₁₆-hydrocarbon-residue is C₂₋₁₂-alkinyl, C₁₋₆-alkyl, C₂₋₆-alkenyl, C₂₋₁₆-alkinyl, C₁₋₄-alkyl, or C₂₋₄-alkenyl. In some embodiments, the C₁₋₁₆-hydrocarbon-residue is C₂₋₁₄-alkinyl, C₁₋₁₂-alkyl, or C₁₋₆-alkyl. In some embodiments, the C₁₋₁₆-hydrocarbon-residue is methyl, ethyl, propyl or butyl. In some embodiments, the C₁₋₁₆-hydrocarbon-residue is methyl.

In some embodiments, the residue —(C₁₋₁₆-alkylene)-OH is —(C₁₋₁₂-alkylene)-OH. In some embodiments, the residue —(C₁₋₁₆-alkylene)-OH is —(C₁₋₆-alkylene)-OH. In some embodiments, the residue —(C₁₋₁₆-alkylene)-OH is —(C₁₋₄-alkylene)-OH. In some embodiments, the residue —(C₁₋₁₆-alkylene)-OH is a methylol group (—CH₂—OH);

In some embodiments, the —O—(C₁₋₁₆-hydrocarbon)-residue is C₁₋₁₆-alkoxy. In some embodiments, the —O—(C₁₋₁₆-hydrocarbon)-residue is C₁₋₁₂-alkoxy. In some embodiments, the —O—(C₁₋₁₆-hydrocarbon)-residue is C₁₋₆-alkoxy. In some embodiments, the —O—(C₁₋₁₆-hydrocarbon)-residue is C₁₋₄-alkoxy. In some embodiments, the —O—(C₁₋₁₆-hydrocarbon)-residue is —O—CH₃, —O—CH₂CH₃, —O—(CH₂)₂CH₃ or —O—(CH₂)₃CH₃.

In some embodiments, the residue —(C₁₋₆-alkylene)-phenyl is —(C₁₋₄-alkylene)-phenyl. In some embodiments, the residue —(C₁₋₆-alkylene)-phenyl is —CH₂-phenyl.

In some embodiments, the residue —(C₁₋₆-alkylene)-phenylene-OH is —(C₁₋₄-alkylene)-phenylene-OH. In some embodiments, the residue —(C₁₋₆-alkylene)-phenylene-OH is —CH₂-phenylene-OH.

In some embodiments, R is a hydrogen atom of a C₁₋₆-hydrocarbon residue (e.g. linear or branched C₁₋₆-alkyl). In some embodiments, R is hydrogen. This is the case, for example, when formaldehyde is used as aldehyde component in a condensation reaction with phenols in order to produce the benzyl ether resin of the formula (IV);

m¹ and m² are each, independently, 0 or 1.

n is an integer from 0 to 100, an integer from 1 to 50, an integer from 2 to 10, or an integer from 2 to 5; and

wherein the sum of n, m¹ and m² is at least 2.

In some embodiments, the polyol component is a phenol resin with monomer units based on cardol and/or cardanol. Cardol and cardanol are produced from cashew nut oil which is obtained from the seeds of the cashew nut tree. Cashew nut oil consists of about 90% anacardic acid and about 10% cardol. By heat treatment in an acid environment, a mixture of cardol and cardanol is obtained by decarboxylation of the anacardic acid. Cardol and cardanol have the structures shown below:

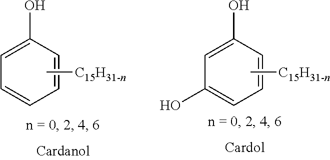

As shown in the illustration above, the hydrocarbon residue (—C₁₅H₃₁₋ₙ) in cardol and/or in cardanol can have one (n=2), two (n=4) or three (n=6) double bonds. Cardol specifically refers to compound CAS-No. 57486-25-6 and cardanol specifically to compound CAS-No. 37330-39-5. Cardol and cardanol can each be used alone or at any particular mixing ratio in the phenol resin. Decarboxylated cashew nut oil can also be used.

Cardol and/or cardanol can be condensed into the above described phenol resins, for example, into the resole- or novolak-type phenol resins. For this purpose, cardol and/or cardanol can be condensed e.g. with phenol or with one or more of the above defined compounds of the formula (III), and also with aldehydes, such as, formaldehyde.

The amount of cardol and/or cardanol which is condensed in the phenol resin is not particularly restricted and can be, for example, from about 1 wt % to about 99 wt %, about 5 wt % to about 60 wt %, or about 10 wt % to about 30 wt %, relative to 100 wt % of the amount of phenolic starting products used in the phenol resin.

In some embodiments, the polyol component is a phenol resin obtained by condensation of cardol and/or cardanol with aldehydes, such as, formaldehyde.

A phenol resin which contains monomer units based on cardol and/or cardanol as described above, or which can be obtained by condensation of cardol and/or cardanol with aldehydes, has a particularly low viscosity and can thus be employed with a low addition or without addition of reactive thinners. Moreover, this kind of long-chain, substituted phenol resin is comparatively hydrophobic, which results in a favorable shelf life of the coated proppants obtained by the methods described herein or those that are incorporated by reference. In addition, a phenol resin of this kind is also advantageous because cardol and cardanol are renewable raw materials.

Apart from the phenol resin, the polyol component can still contain other compounds containing hydroxyl groups, e.g., castor oil. Compounds containing hydroxyl groups such as alcohols or glycols, for example, cardol and/or cardanol, can be used as reactive thinners or carriers for dyes, pigment suspensions, or other additives that are incorporated into the coating.

The amount of the other compounds containing hydroxyl groups depends on the desired properties of the proppant coating and can suitably be selected by the person skilled in the art. Typical amounts of compounds containing hydroxyl groups are from about 10 wt % and about 80 wt %, from about 20 wt % to about 70 wt %, relative to 100 wt % of the polyol component.

The methods described herein can be also be used when proppants are coated with a condensation reaction product that has been made with an excess of isocyanate component with respect to the polyol component. In some embodiments, in the first step of the mixing, or formulation process, therefore, 1 part by weight of the polyol component is used at an amount from about 100 wt % to about 10,000 wt %, about 100 wt % to about 5,000 wt %, about 100 wt % to about 200 wt %, or about 100 wt % to about 150 wt %, about 102 wt % to about 5,000 wt %, about 102 wt % to about 200 wt %, or about 102 wt % to about 150 wt % of the isocyanate base value.

The isocyanate base value defines the amount of the isocyanate component which is equivalent to 100 parts by weight of the polyol component. The NCO-content (%) of the isocyanate component is defined herein according to DIN ISO 53185. To determine the OH-content (%) of the polyol component, first the so-called OH-number is determined in mg KOH/g according to DIN ISO 53240 and this value is divided by 33, in order to determine the OH-content.

Moreover, in the initial step described above, in some embodiments, one or more additives can be mixed with the proppant, the polyol component and the isocyanate component. These additives are not particularly restricted and can be selected from the additives known in the specific field of coated proppants. Provided that one of these additives has hydroxyl groups, it should be considered as a different hydroxyl-group-containing compound, as described above in connection with the polyol component. If one of the additives has isocyanate groups, it should be considered as a different isocyanate-group-containing compound. Additives with hydroxyl groups and isocyanate groups can be simultaneously considered as different hydroxyl-group-containing compounds and as different isocyanate-group-containing compounds.

In some embodiments, attaching the treatment agent can require an additive which is (a) reactive with the isocyanate or (b) reactive with the polyol or (c) reactive with the curing agent to be used. Thus, additives (or combinations of additives) such as ethanolamines, aminoacids, phenolsulfonic acids, salicylates, and quaternary ammonium compounds can be introduced into or into the proppant as an additive in the coating process whereby the removal component with water cleaning functionality is directly incorporated into the coating of the proppant.

It some embodiments, the treatment agent is incorporated as a particulate treatment agent, wherein the coating on the proppant functions to stick the additive to the surface of the proppant and thereby cause the particulates to become associated like a single particle, enabling the dual actions of propping and treating. Examples of this type of particulate treating agent would be a finely powdered form of commercial water treatment resins, such as anion exchange resins, cation exchange resins, and/or chelating ion exchange resins.

Alternatively, a physical blend of the coated or uncoated proppant particles and ion exchange resins beads can be used in the fracturing process as a method of introducing the combination of proppants and water/hydrocarbon cleaning activity. This physical blend could consolidate in the fracture to immobilize the ion exchange resin beads, thus creating a capability to clean the fluid passing through the pack within the fracture.

In some embodiments, the proppant product would be a blend of compositionally different proppant solids and/or proppant properties. For example, some proppants can be formulated to remove one type of contaminant while other proppant solids in the blend would target a different contaminant. The ratio of a coated proppant solid blend can vary broadly from about 1:1000 to 1000:1.

The coating formulation may also include a reactive amine component that is different from the polyol reactant. In some embodiments, the reactive amine component is an amine-terminated compound. This component enhances crosslink density within the coating and, depending on component selection, can provide additional characteristics of benefit to the cured coating. In some embodiments, the reactive amine components includes, but is not limited to, amine-terminated compounds such as diamines, triamines, amine-terminated glycols such as the amine-terminated polyalkylene glycols sold commercially under the trade name JEFFAMINE from Huntsman Performance Products in The Woodlands, Tex.

Suitable diamines include, but are not limited to, primary, secondary and higher polyamines and amine-terminated compounds. Suitable compounds include, but are not limited to, ethylene diamine; propylenediamine; butanediamine; hexamethylenediamine; 1,2-diaminopropane; 1,4-diaminobutane; 1,3-diaminopentane; 1,6-diaminohexane; 2,5-diamino-2,5-dimethlhexane; 2,2,4- and/or 2,4,4-trimethyl-1,6-diaminohexane; 1,11-diaminoundecane; 1,12-diaminododecane; 1,3- and/or 1,4-cyclohexane diamine; 1-amino-3,3,5-trimethyl-5-aminomethyl-cyclohexane; 2,4- and/or 2,6-hexahydrotoluylene diamine; 2,4′ and/or 4,4′-diaminodicyclohexyl methane and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,6-diaminotoluene and 2,4′ and/or 4,4′-diaminodiphenyl methane; and polyoxyalkylene polyamines (also referred to herein as amine terminated polyethers).

Mixtures of polyamines may also be employed in preparing aspartic esters, which is a secondary amine derived from a primary polyamine and a dialkyl maleic or fumaric acid ester. Representative examples of useful maleic acid esters include dimethyl maleate, diethyl maleate, dibutyl maleate, dioctyl maleate, mixtures thereof and homologs thereof.

Suitable triamines and higher multifunctional polyamines for use in the present coatings include diethylene triamine, triethylenetetramine, and higher homologs of this series.

JEFFAMINE diamines include the D, ED, and EDR series products. The D signifies a diamine, ED signifies a diamine with a predominately polyethylene glycol (PEG) backbone, and EDR designates a highly reactive, PEG based diamine.

JEFFAMINE D series products are amine terminated polypropylene glycols with the following representative structure:

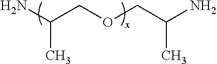

| JEFFAMINE ® | x | MW* |
|---|---|---|
| D-230 | ~2.5 | 230 |
| D-400 | ~6.1 | 430 |
| D-2000 | ~33 | 2,000 |
| D-4000 (XTJ-510) | ~68 | 4,000 |

JEFFAMINE EDR-148 (XTJ-504) and JEFFAMINE EDR-176 (XTJ-590) amines are much more reactive than the other JEFFAMINE diamines and triamines. They are represented by the following structure:

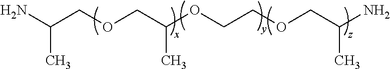

| JEFFAMINE ® | y | x + z | MW* |
|---|---|---|---|
| HK-511 | 2.0 | ~1.2 | 220 |
| ED-600 (XTJ-500) | ~9.0 | ~3.6 | 600 |
| ED-900 (XTJ-501) | ~12.5 | ~6.0 | 900 |
| ED-2003 (XTJ-502) | ~39 | ~6.0 | 2,000 |

JEFFAMINE T series products are triamines prepared by reaction of propylene oxide (PO) with a triol initiator followed by amination of the terminal hydroxyl groups. They are exemplified by the following structure:

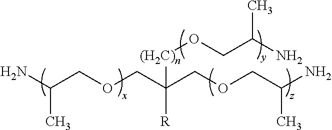

| | | | Moles PO | |
|---|---|---|---|---|
| JEFFAMINE ® | R | n | (x + y + z) | MW* |
| T-403 | C₂H₅ | 1 | 5-6 | 440 |
| T-3000 (XTJ-509) | H | 0 | 50 | 3000 |
| T-5000 | H | 0 | 85 | 5000 |

The SD Series and ST Series products consist of secondary amine versions of the JEFFAMINE core products. The SD signifies a secondary diamine and ST signifies a secondary triamine. The amine end-groups are reacted with a ketone (e.g. acetone) and reduced to create hindered secondary amine end groups represented by the following terminal structure:

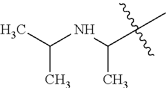 [SMILES: *C(C)NC(C)C]

One reactive hydrogen on each end group provides for more selective reactivity and makes these secondary di- and triamines useful for intermediate synthesis and intrinsically slower reactivity compared with the primary JEFFAMINE amines.

| JEFFAMINE ® | Base Product | MW* |
|---|---|---|
| SD-231 (XTJ-584) | D-230 | 315 |
| SD-401 (XTJ-585) | D-400 | 515 |
| SD-2001 (XTJ-576) | D-2000 | 2050 |
| ST-404 (XTJ-586) | T-403 | 565 |

See also U.S. Pat. Nos. 6,093,496; 6,306,964; 5,721,315; 7,012,043; and Publication U.S. Patent Application No. 2007/0208156 the disclosures of which are hereby incorporated by reference.

An amine-based latent curing agent may optionally be added to the coating formulation with the isocyanate component, the polyol component, the amine-reactive polyol component or added simultaneously as any of these components or pre-coated on the proppant. Suitable amine-based latent curing agents include, but are not limited to, triethylenediamine; bis(2-dimethylaminoethyl)ether; tetramethylethylenediamine; pentamethyldiethylenetriamine; and other tertiary amine products of alkyleneamines. Additionally, other catalysts that promote the reaction of isocyanates with hydroxyls and amines that are known by the industry can be used.

In some embodiments, amine-based latent curing agents may be added in an amount within the range from about 0.1 to about 10% by weight relative to the total weight of the coating resin.

In some embodiments, the proppant coating compositions may also include various additives. For example, the coatings may also include pigments, tints, dyes, and fillers in an amount to provide visible coloration in the coatings. Other materials that can be conventionally included in coating compositions may also be added to the compositions. These additional materials include, but are not limited to, reaction enhancers or catalysts, crosslinking agents, optical brighteners, propylene carbonates, coloring agents, fluorescent agents, whitening agents, UV absorbers, hindered amine light stabilizers, defoaming agents, processing aids, mica, talc, nano-fillers and other conventional additives. All of these materials are well known in the art and are added for their usual purpose in typical amounts. For example, the additives can be present in an amount of about 15 weight percent or less. In some embodiments, the additive is present in an amount of about 5 percent or less by weight of the coating composition.

In some embodiments, high surface area fillers, including porous or semi-porous fillers, can also be used to deliver functional chemicals, such as metals, catalysts, neutralizing agents, surfactants, or other such chemicals when mixed into a polymeric proppant coating. The high surface area allows for physical mixing and/or chemical tethering of active chemicals onto the filler. These active chemicals can then be released when the coated proppants (with the chemically treated fillers) are placed in situ in a well, or come in contact with chemicals which they are designed to counteract. In some embodiments, they can also be used in a timed release fashion by tailoring the polymer coating to dissolve over time, or bonding the active chemicals with the carriers through chemically vulnerable bonds such as those polymers with polyester bonds that might hydrolyze over time under downhole conditions.

In some embodiments, mesoporous silica is a material that can be used as a porous delivery carrier. Many organic chemicals and catalysts can also be encapsulated in mesoporous silica via this technique. The chemicals that are encapsulated in the mesoporous silica or bound to fumed silica might then be delivered by mixing the silica/chemical combination into a resin coating as a filler. Once exposed to downhole conditions, the active chemical is released from the formulation via dissolution, diffusion or similar mechanisms. For example, mesoporous silica has been used to deliver drugs, as its high surface area and porosity allow for high levels of functional ingredient delivery and also for potential timed release of internally encapsulated chemicals (see, Mellaerts et al., J. Chem. Commun., 2007, 1375-1377). Many organic chemicals and catalysts can also be encapsulated in mesoporous silica via this technique (see, Cao et al., ISRN Nanomaterials, vol. 2013, Article ID 745397, 7 pages, 2013). The chemicals that are encapsulated in the mesoporous silica or bound to fumed silica might then be delivered by mixing the silica/chemical combination into a resin coating as a filler. Once exposed to downhole conditions, the active chemical can be released from the formulation via dissolution, diffusion or similar mechanisms.

Other porous carrier particulates that can be added into or adhered to the outer coating layer with physically mixed or chemically treated fumed silica or activated carbon, carbon black, or carbon nanotubes. In some embodiments, these treated fillers can be used to include active chemicals into a resin coating via their intimate association with high surface area fillers. Carbon black and/or activated carbon have been used as a carrier for chemicals that might be delivered through timed release formulations (see, U.S. Pat. No. 5,856,271). Carbon nanotubes have been used as carriers to deliver functional chemistries as well. For example, metal oxides can be coated onto nanotubes, and the coated nanotubes can be used formulations to deliver the oxide (see, Carbon 44, 7, (2006), pages 1166-1172; available on the world wide web at sciencedirect(dot)com/science/article/pii/S0008622305006664). These treated fillers can be used in the present disclosure as another method of including active chemicals into a resin coating via their intimate association with high surface area fillers.

Other additives can include, for example, solvents, softeners, surface-active agents, molecular sieves for removing the reaction water, thinners and/or adhesion agents can be used. In some embodiments, silanes are a used as an adhesion agent that improves, for example, the affinity of the coating resin for the surface of the proppant. Silanes can be mixed in as additives in the formulation process, but can also be converted chemically with reactive constituents of the polyol component or of the isocyanate component. Functional silanes such as amino-silanes, epoxy-, aryl- or vinyl silanes are commercially available and, as described above, can be used as additives or can be converted with the reactive constituents of the polyol component or of the isocyanate component. In particular, amino-silanes and epoxy-silanes can be easily converted with the isocyanate component.

In some embodiments, the method for the production of coated proppants can be implemented without the use of solvents. Accordingly, the mixture obtained in the formulation process is solvent-free, or is essentially solvent-free. The mixture is essentially solvent-free, if it contains less than 20 wt %, less than 10 wt %, less than 5 wt %, less than 3 wt %, or less than 1 wt % of solvent, relative to the total mass of components of the mixture.

In some embodiments, during the formulation process, the proppant is heated to an elevated temperature and then contacted with the coating components. In some embodiments, the proppant is heated to a temperature within the range of about 50° C. to about 150° C. to accelerate crosslinking reactions in the applied coating.

A mixer can be used for the coating process and is not particularly restricted and can be selected from among the mixers known in the specific field. For example, a pug mill mixer or an agitation mixer can be used. For example, a drum mixer, a plate-type mixer, a tubular mixer, a trough mixer or a conical mixer can be used. In some embodiments, the mixing is performed in a rotating drum although a continuous mixer or a worm gear can also be used for a period of time within the range of 1-6 minutes, or a period of 2-4 minutes during which the coating components are combined and simultaneously reacted on the proppant solids within the mixer while the proppant solids are in motion.

Mixing can also be carried out on a continuous or discontinuous basis. In suitable mixers it is possible, for example, to add adhesion agents, isocyanate, amine and optional ingredients continuously to the heated proppants. For example, isocyanate components, amine reactant and optional additives can be mixed with the proppant solids in a continuous mixer (such as a worm gear) in one or more steps to make one or more layers of cured coating.

In some embodiments, the proppant, isocyanate component, amine reactant and the optional additives are mixed simultaneously or sequentially. They also can be mixed together into a homogeneous mixture before being applied to the proppant. Therefore, in some embodiments, the isocyanate component and amine reactant are distributed uniformly on the surface of the proppants. In some embodiments, the coating ingredients are kept in motion throughout the entire mixing process. It is also possible to arrange several mixers in series, or to coat the proppants in several runs in one mixer.

The temperature of the coating process is not particularly restricted outside of practical concerns for safety and component integrity. In some embodiments, the coating step is performed at a temperature of from about 10° C. to about 200° C., from about 10° C. to about 150° C., from about 20° C. to about 200° C., from about 20° C. to about 150° C., from about 30° C. to about 200° C., from about 30° C. to about 150° C., from about 40° C. to about 200° C., from about 40° C. to about 150° C., from about 50° C. to about 200° C., from about 50° C. to about 150° C., from about 60° C. to about 200° C., from about 60° C. to about 150° C., from about 70° C. to about 200° C., from about 70° C. to about 150° C., from about 80° C. to about 200° C., from about 80° C. to about 150° C., from about 90° C. to about 200° C., from about 90° C. to about 150° C., from about 100° C. to about 200° C., or from about 100° C. to about 150° C.

In some embodiments, the coating material may be applied in more than one layer. In some embodiments, the coating process is repeated as necessary (e.g. 1-5 times, 2-4 times or 2-3 times) to obtain the desired coating thickness and/or synthetically place the water/hydrocarbon cleaning activity within layers on the coated proppant. In some embodiments, the thickness of the coating of the proppant can be adjusted and used as either a relatively narrow range of proppant size or blended with proppants of other sizes, such as those with more or less numbers of coating layers of polyurethane as described, so as to form a proppant blend have more than one range of size distribution. In some embodiments, a range for coated proppant is about 20-70 mesh.

In some embodiments, the amount of coating, that is, of the polyurethane resin and any treatment agent that is applied as part of the coating, is applied to the outer surface of proppant solids is at an amount within the range from about 1.5 to about 12 wt %, about 2 to about 8 wt %, resin relative to the mass of the uncoated proppant as 100 wt %. The amount of the applied treatment agent alone, excluding the weight of any applied resin, can be from about 1 to about 5 wt % relative to the mass of the uncoated proppant.

The coated proppants can additionally be treated with surface-active agents or auxiliaries, such as talcum powder or stearate, to improve pourability.

In some embodiments, the coated proppants can be baked or heated for a period of time sufficient to substantially react at least substantially all of the available isocyanate, hydroxyl and reactive amine groups that might remain in the coated proppant. Such a post-coating cure may occur even if additional contact time with a catalyst is used after a first coating layer or between layers. In some embodiments, the post-coating cure step is performed like a baking step at a temperature from about 100°-200° C. for a time of about 0.5-12 hours or at a temperature from about 125°-175° C. for 0.25-2 hours. In some embodiments, the coated proppant is cured for a time and under conditions sufficient to produce a coated proppant that exhibits a loss of coating of less than 25 wt %, less than 15 wt %, or less than 5 wt % when tested according to ISO 13503-5:2006(E).

With the method proppants can be coated at temperatures between about 10° C. and about 200° C., including, but not limited to, in a solvent-free manner, and combined with a treatment agent component such as a NORMS or heavy metal ion exchange or zeolitic material, to effect both stratum fracturing and a measure of contaminant removal from the produced water and hydrocarbons while also reducing proppant flowback.

### Using the Treatment Agent Proppant Formulation

Furthermore, embodiments descried herein provide the use of the treatment agent proppant formulation in conjunction with a fracturing liquid for the production of petroleum or natural gas. The fracturing liquid is not particularly restricted and can be selected from among the frac liquids known in the specific field. Suitable fracturing liquids are described, for example, in W C Lyons, G J Plisga, Standard Handbook Of Petroleum And Natural Gas Engineering, Gulf Professional Publishing (2005). The fracturing liquid can be, for example, water gelled with polymers, an oil-in-water emulsion gelled with polymers, a water-in-oil emulsion gelled with polymers or gelled/ungelled hydrocarbon. In some embodiments, the fracturing liquid comprises the following constituents in the indicated proportions: 1000 l water, 20 kg potassium chloride, 0.120 kg sodium acetate, 3.6 kg guar gum (water-soluble polymer), sodium hydroxide (as needed) to adjust a pH-value from 9 to 11, 0.120 kg sodium thiosulfate, and 0.180 kg ammonium persulfate. In some embodiments, the liquid comprises a crosslinker, such as but not limited to a crosslinker that provides a source of boron. Non-limiting examples of cross-linkers are boric acid, sodium borate, or a combination thereof.

In addition, methods for the production of petroleum or natural gas are provided which comprises the injection of the coated proppant into the fractured stratum with the fracturing liquid, i.e., the injection of a fracturing liquid which contains the coated proppant, into a petroleum- or natural gas-bearing rock layer, and/or its introduction into a fracture in the rock layer bearing petroleum or natural gas. The method is not particularly restricted and can be implemented in the manner known in the specific field.

When the method of cleaning the water/hydrocarbon makes it most efficient to use a physical blend of the proppant and one or more commercial ion exchange resins or zeolites, these blends can be produced at the manufacturing site of the proppant coating process or completed at the wellbore during the fracturing process.

Additionally, provided herein are methods of treating a fractured subterranean stratum comprising contacting a fractured stratum with a proppant that comprises a hydrophobic coating, a coating that inhibits the formation of scale, a coating that reduces friction, a coating that controls sulfides, an acid or base resistant coating, a coating that inhibits corrosion, a coating that inhibits paraffin precipitation, or a coating that inhibits asphaltene precipitation.

In some embodiments of the methods, the proppant comprises a hydrophobic coating comprising a silane, chlorosilane, or fluorosilane. In some embodiments, the coating that inhibits the formation of scale is a polymeric coating that inhibits the formation of scale. In some embodiments, the polymeric coating comprises a phosphino-polycarboxylate, polyacrylate, polyvinylsulphonic acid, or sulphonated polyacrylate co-polymer. In some embodiments, the coating that inhibits the formation of scale is a nonpolymeric coating that inhibits the formation of scale. In some embodiments, the nonpolymeric coating comprises fumaric acid; diethylene glycol; phosphorous acid; trisodium 2,2′-({2-[(carboxylatomethyl)amino]ethyl}imino)diacetate; sodium glycolate; glycine; trisodium nitrilotriacetate; 1,2-propylene glycol; methoxyacetic acid; methylphosphonic acid; polyphosphoric acids; alkylbenzene; phosphino-carboxylic acid; trisodium ortho phosphate; or sodium polyacrylate.

In some embodiments of the methods, the coating that reduces friction reduces friction on fluid flow. In some embodiments, the coating that reduces friction comprises ethoxylated oleylamine; caprylic alcohol; C₆₋₁₂ ethoxylated alcohols; C₁₂₋₁₄ ethoxylated alcohols; C₁₂₋₁₆ ethoxylated alcohols; a superhydrophobic coating; a polybutadiene-containing polymer; a polyurethane with aliphatic segments; polymethylmethacrylate; a polydimethylsiloxane; or a non-ionic, water-soluble poly(ethylene) oxide polymer.

In some embodiments of the methods, the coating that controls sulfides comprises at least one of a copper salt, zinc oxide, ferric oxide, a solid permanganate, a quinone, benzoquinone, a napthoquinone, an agent containing quinone functional groups, a polymer with pendant aldehyde groups, a dendrimer with terminal aldehyde groups, a dioxole monomer or polymer, an amine-terminated polymer, a metal carboxylate or chelate that forms an insoluble metal sulfate, a polyvinylferrocene, a polyferrocenylacrylates, or a nitrate salt.

In some embodiments of the methods, the acid or base resistant coating comprises a polypropylene, an acrylic polymer, and a fluoropolymers other than fluoropolymers containing vinylidene fluoride. In some embodiments of the methods, the coating that inhibits corrosion comprises zinc particles; aluminum particles; 1-benzylquinolinium chloride; acetaldehyde; ammonium bisulfite; benzylideneacetaldehyde; castor oil; copper chloride; a fatty acid esters; formamide; octoxynol 9; potassium acetate; propargyl alcohol; propylene glycol butyl ether; 1-(phenylmethyl)-pyridinium; a tall oil fatty acid; a tar base; quaternized benzyl chloride; triethylphosphate; polyvinylpyridine; or polyvinylpyrrolidone.

In some embodiments of the methods, the coating that inhibits paraffin precipitation comprises a styrene ester copolymer, a styrene ester terpolymer, a polyalkylated phenol, a fumerate-vinyl acetate copolymer, a copolymer of acrylic ester and allyl ether, urea, an unsaturated dicarboxylic acid imides with an ethylene-vinlyacetate backbone, a dicarboxylic acid amide, a dicarboxylic acid half amides, an ethylene-vinyl acetate copolymer, an acrylate polymers, or a maleic anhydride copolymer.

In some embodiments of the methods, the coating that inhibits asphaltene precipitation is a polymer that comprises an alkylphenol/aldehyde resin; a polyolefin ester, amide, or imide with alkyl, alkylene phenyl, or alkylene pyridyl functional groups; an alkenylpyrolidone copolymer; a graft polymer of polyolefins with maleic anhydride or vinylimidazole; a hyperbranched polyesterimide; a lignosulfonate; or a polyalkoxylated asphaltene.

In some embodiments, the methods also comprise propping a fracture subterranean stratum with the proppant. In some embodiments, the propping comprises introducing into the stratum the proppant in a sufficient amount to prop open fractures in the stratum

As discussed herein, the proppant comprises a tracer, an impact modifier coating, a coating for timed or staged release of an additive, or any combination thereof.

Methods of treating a fractured subterranean stratum, the method comprising contacting the fractured stratum with a proppant that comprises a hydrophobic coating, a coating that inhibits the formation of scale, a coating that reduces friction, a coating that controls sulfides, an acid or base resistant coating, a biocidal coating, a coating that inhibits corrosion, a coating that inhibits paraffin precipitation, or a coating that inhibits asphaltene precipitation, wherein the proppant comprises a core solid having 1.5-12 wt % of a hard, glassy, cured, polyurethane coating over substantially the entirety of the surface of the core solid, wherein the polyurethane coating has been made with a multifunctional polyether polyol and an excess of an isocyanate and which develops an interparticle bond strength of at least 100 psi in unconfined compressive strength testing. In some embodiments, the proppant comprises a coating that comprises a tracer, an impact modifier coating, a coating for timed or staged release of an additive, or any combination thereof. In some embodiments, the method comprises introducing into the stratum the proppant in a sufficient amount to prop open fractures in the stratum.

1. As described herein, proppants comprising a coating are provided. In some embodiments, the coating is a hydrophobic coating, a biocidal coating, a coating that inhibits the formation of scale, a coating that reduces friction, a coating that controls sulfides, an acid or base resistant coating, a coating that inhibits corrosion, a coating that inhibits paraffin precipitation, a coating that inhibits asphaltene precipitation, a coating that comprises a tracer, an impact modifier coating, a coating for timed or staged release of an additive, or any combination thereof. In some embodiments, the proppant comprises a hydrophobic coating comprising a polybutadiene, a silane, an alkoxysilane, a surfactant, a chlorosilane, or a fluorosilane. In some embodiments, the hydrophobic coating comprises an alkoxylated alcohol. In some embodiments, the hydrophobic coating comprises an amorphous polyalphaolefin. In some embodiments, the polyalphaolefin polymer is a crosslinked polyalphaolefin polymer. In some embodiments, the hydrophobic coating is a non-siloxane hydrophobic polymer. In some embodiments, the hydrophobic coating is a cured hydrophobic polymer.

In some embodiments, the coating that inhibits the formation of scale is a polymeric coating that inhibits the formation of scale. In some embodiments, the polymeric coating comprises a phosphino-polycarboxylate, polyacrylate, polyvinylsulphonic acid, or sulphonated polyacrylate co-polymer. In some embodiments, the coating that inhibits the formation of scale is a nonpolymeric coating that inhibits the formation of scale. In some embodiments, the nonpolymeric coating comprises fumaric acid; diethylene glycol; phosphorous acid; trisodium 2,2′-({2-[(carboxylatomethyl)amino]ethyl}imino)diacetate; sodium glycolate; glycine; trisodium nitrilotriacetate; 1,2-propylene glycol; methoxyacetic acid; methylphosphonic acid; polyphosphoric acids; alkylbenzene; phosphino-carboxylic acid; trisodium ortho phosphate; or sodium polyacrylate.

In some embodiments, the coating that reduces friction reduces friction on fluid flow. In some embodiments, the coating that reduces friction comprises ethoxylated oleylamine; caprylic alcohol; C₆₋₁₂ ethoxylated alcohols; C₁₂₋₁₄ ethoxylated alcohols; C₁₂₋₁₆ ethoxylated alcohols; a superhydrophobic coating; a polybutadiene-containing polymer; a polyurethane with aliphatic segments; polymethylmethacrylate; a polydimethylsiloxane; or a non-ionic, water-soluble poly(ethylene) oxide polymer.

In some embodiments, the proppant comprises a coating that controls sulfides that comprises at least one of a copper salt, zinc oxide, ferric oxide, a solid permanganate, a quinone, benzoquinone, a napthoquinone, an agent containing quinone functional groups, a polymer with pendant aldehyde groups, a dendrimer with terminal aldehyde groups, a dioxole monomer or polymer, an amine-terminated polymer, a metal carboxylate or chelate that forms an insoluble metal sulfate, a polyvinylferrocene, a polyferrocenylacrylates, or a nitrate salt.

In some embodiments, the proppant comprises an acid or base resistant coating comprises a polypropylene, an acrylic polymer, and a fluoropolymers other than fluoropolymers containing vinylidene fluoride.

In some embodiments, the proppant comprises a coating that inhibits corrosion that comprises zinc particles; aluminum particles; 1-benzylquinolinium chloride; acetaldehyde; ammonium bisulfite; benzylideneacetaldehyde; castor oil; copper chloride; a fatty acid esters; formamide; octoxynol 9; potassium acetate; propargyl alcohol; propylene glycol butyl ether; 1-(phenylmethyl)-pyridinium; a tall oil fatty acid; a tar base; quaternized benzyl chloride; triethylphosphate; polyvinylpyridine; or polyvinylpyrrolidone.

In some embodiments, the proppant comprises a coating that inhibits paraffin precipitation that comprises a styrene ester copolymer, a styrene ester terpolymer, a polyalkylated phenol, a fumerate-vinyl acetate copolymer, a copolymer of acrylic ester and allyl ether, urea, an unsaturated dicarboxylic acid imides with an ethylene-vinlyacetate backbone, a dicarboxylic acid amide, a dicarboxylic acid half amides, an ethylene-vinyl acetate copolymer, an acrylate polymers, or a maleic anhydride copolymer.

In some embodiments, the proppant comprises a coating that inhibits asphaltene precipitation, wherein the coating comprises a polymer that comprises an alkylphenol/aldehyde resin; a polyolefin ester, amide, or imide with alkyl, alkylene phenyl, or alkylene pyridyl functional groups; an alkenylpyrolidone copolymer; a graft polymer of polyolefins with maleic anhydride or vinylimidazole; a hyperbranched polyesterimide; a lignosulfonate; or a polyalkoxylated asphaltene.

As described herein, the proppants can comprise a coating that comprises a tracer, an impact modifier coating, a coating for timed or staged release of an additive, or any combination thereof.

Also provided are resin-coated proppant that comprises a cured polyurethane coating associated with a polymeric treatment agent component, wherein the proppant comprises a core solid having a hard, glassy, cured, polyurethane coating over substantially the entirety of the surface of the core solid, wherein the polyurethane coating has been made with a multifunctional polyether polyol and an excess of an isocyanate and which develops an interparticle bond strength of at least 100 psi in unconfined compressive strength testing, wherein the treatment agent component comprises: (a) a hydrophobic coating, (b) a coating that inhibits the formation of scale, (c) a coating that reduces friction, (d) a coating that comprises a tracer, (e) an impact modifier coating, (f) a coating for timed or staged release of an additive, (g) a coating that controls sulfides, (h) a polymeric coating other than a polymer formed from the first treatment agent, (i) an acid or base resistant coating, (j) a coating that inhibits corrosion, (k) a coating that increases proppant crush resistance, (l) a coating that inhibits paraffin precipitation, (m) a coating that inhibits asphaltene precipitation, (n) a coating comprising an ion exchange resin that removes anions and/or halogens, or any combination thereof.

Various coatings, treatment agent components, or additives are described herein. These coatings, treatment agent components, and additives can be used alone or in combination with one another. As described herein, they can be incorporated into the same layer or in separate layers by subsequent coating applications. They can be applied using any process to coat a proppant, such as, but not limited to, the processes described herein or those that are incorporated by reference.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In the present disclosure various ranges are described. The embodiments include the end points of the range.

### EXAMPLES

### Example 1

### Inhibition of Scale Formation in a Fractured Subterranean Stratum

Proppant sand is coated with a polymeric coating that inhibits the formation of scale. The proppant is coated by mixing the sand with the polymeric coating. The polymeric coating is phosphino-polycarboxylate. The proppant sand is introduced into a fractured subterranean stratum. The proppant sand inhibits the formation of scale in the fractured subterranean stratum.

### Example 2

### Biocidal Proppant Inhibits Growth of Algae in a Fractured Subterranean Stratum

Proppant sand is coated with a biocidal coating comprising 2,2-dibromo-3-nitrilopropionamide. The biocidal coating is applied with a flash coating process that limits the amount of the biocidal coating applied to the proppant sand while maintaining the free flowing nature of the proppant sand. The biocidial coated sand is introduced into a fractured subterranean stratum. The growth of algae is inhibited in the fractured subterranean stratum.

### Example 3

### Increased Crush Resistance

Increased crush resistance (“K values”) can be obtained with polyurethane-treated proppant sand relative to its untreated version at even low coating levels. Proppant sand was coated with a polyurethane coating. The proppant sand was test for crush resistance. The results are shown in Table 1. The polyurethane coating increased crush resistance as compared to the raw sand.

TABLE 1
K values From Crush Tests, per ISO 13503-2

| | | Improvement over Raw |
|---|---|---|
| PU Coating Weight | Crush test, K value | Sand |
| 0% | 6 | 0% |
| (untreated 20/40 sand) | | (control) |
| 0.25% | 7 | 17% |
| 0.25% | 7 | 17% |
| 0.31% | 7 | 17% |
| 0.50% | 10 | 67% |
| 0.53% | 10 | 67% |

Various references, publications and patents are disclosed herein, each of which are hereby incorporated by reference in their entirety, and, for the purpose that they are cited.

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting.

1. A method of treating a fractured subterranean stratum comprising:
contacting the fractured stratum with a proppant that comprises one or more of a hydrophobic coating, a coating that inhibits the formation of scale, a coating that reduces friction, a coating that controls sulfides, an acid or base resistant coating, a coating that inhibits corrosion, a coating that inhibits paraffin precipitation, a biocidal coating, a coating that inhibits asphaltene precipitation, a coating that inhibits hydrates and/or hydrate agglomerates, or a coating that contains and/or releases a compound that acts as a clay stabilizer.

2. The method of claim 1, wherein the proppant comprises a hydrophobic coating comprising a silane, chlorosilane, or fluorosilane.

3. The method of claim 1, wherein the coating that inhibits the formation of scale is a polymeric coating that inhibits the formation of scale.

4. The method of claim 3, wherein the polymeric coating comprises a phosphino-polycarboxylate, polyacrylate, polyvinylsulphonic acid, or sulphonated polyacrylate co-polymer.

5. The method of claim 1 wherein the coating that inhibits the formation of scale is a nonpolymeric coating that inhibits the formation of scale.

6. The method of claim 5, wherein the nonpolymeric coating comprises fumaric acid; diethylene glycol; phosphorous acid; trisodium 2,2′-({2-[(carboxylatomethyl)amino]ethyl}imino)diacetate; sodium glycolate; glycine; trisodium nitrilotriacetate; 1,2-propylene glycol; methoxyacetic acid; methylphosphonic acid; polyphosphoric acids; alkylbenzene; phosphino-carboxylic acid; trisodium ortho phosphate; sodium polyacrylate; or diatomaceous earth.

7. (canceled)

8. The method of claim 1, wherein the coating that reduces friction comprises ethoxylated oleylamine; caprylic alcohol; C₆₋₁₂ ethoxylated alcohols; C₁₂₋₁₄ ethoxylated alcohols; C₁₂₋₁₆ ethoxylated alcohols; a superhydrophobic coating; a polybutadiene-containing polymer; a polyurethane with aliphatic segments; polymethylmethacrylate; a polydimethylsiloxane; or a non-ionic, water-soluble poly(ethylene) oxide polymer.

9. The method of claim 1, wherein the coating that controls sulfides comprises at least one of a copper salt, zinc oxide, ferric oxide, a solid permanganate, a quinone, benzoquinone, a napthoquinone, an agent containing quinone functional groups, a polymer with pendant aldehyde groups, a dendrimer with terminal aldehyde groups, a dioxole monomer or polymer, an amine-terminated polymer, a metal carboxylate or chelate that forms an insoluble metal sulfate, a polyvinylferrocene, a polyferrocenylacrylates, or a nitrate salt.

10. The method of claim 1, wherein the acid or base resistant coating comprises a polypropylene, an acrylic polymer, and a fluoropolymer other than fluoropolymers containing vinylidene fluoride.

11. The method of claim 1, wherein the coating that inhibits corrosion comprises zinc particles; aluminum particles; 1-benzylquinolinium chloride; acetaldehyde; ammonium bisulfite; benzylideneacetaldehyde; castor oil; copper chloride; a fatty acid esters; formamide; octoxynol 9; potassium acetate; propargyl alcohol; propylene glycol butyl ether; 1-(phenylmethyl)-pyridinium; a tall oil fatty acid; a tar base; quaternized benzyl chloride; triethylphosphate; polyvinylpyridine; or polyvinylpyrrolidone.

12. The method of claim 1, wherein the coating that inhibits paraffin precipitation comprises a styrene ester copolymer, a styrene ester terpolymer, a polyalkylated phenol, a fumerate-vinyl acetate copolymer, a copolymer of acrylic ester and allyl ether, urea, an unsaturated dicarboxylic acid imides with an ethylene-vinlyacetate backbone, a dicarboxylic acid amide, a dicarboxylic acid half amides, an ethylene-vinyl acetate copolymer, an acrylate polymers, or a maleic anhydride copolymer.

13. The method of claim 1, wherein the coating that inhibits asphaltene precipitation is a polymer that comprises an alkylphenol/aldehyde resin; a polyolefin ester, amide, or imide with alkyl, alkylene phenyl, or alkylene pyridyl functional groups; an alkenylpyrolidone copolymer; a graft polymer of polyolefins with maleic anhydride or vinylimidazole; a hyperbranched polyesterimide; a lignosulfonate; or a polyalkoxylated asphaltene.

14. The method of claim 1, wherein the coating that inhibits hydrates or hydrate agglomerates comprises a layer of an alkylated ammonium compound, an alkylated phosphonium compound, an alkylated sulfonium compound, or any combination thereof, and optionally a polymeric coating to encapsulate the layer that allows a timed or staged release of the alkylated ammonium compound, an alkylated phosphonium compound, an alkylated sulfonium compound, or any combination thereof.

15. The method of claim 1, wherein the coating that stabilizes clay comprises a surfactant, an alkyl salt, a quaternary ammonium compound, a pyridinium salt, or any combination thereof.

16-22. (canceled)

23. The method of claim 1, wherein the proppant comprises a coating that comprises a tracer, an impact modifier coating, a coating for timed or staged release of an additive, or any combination thereof.

24. A method of treating a fractured subterranean stratum, the method comprising:
contacting the fractured stratum with a proppant that comprises one or more of a hydrophobic coating, a coating that inhibits the formation of scale, a coating that reduces friction, a biocidal coating, a coating that controls sulfides, an acid or base resistant coating, a coating that inhibits corrosion, a coating that inhibits paraffin precipitation, a coating that inhibits asphaltene precipitation, a coating that inhibits hydrate formation, a coating that inhibits hydrate agglomeration, or a coating that contains and/or releases a compound that acts as a clay stabilizer,
wherein the proppant comprises a core solid having 1.5-12 wt % of a hard, glassy, cured, polyurethane coating over substantially the entire surface of the core solid, wherein the polyurethane coating has been made with a multifunctional polyether polyol and an excess of an isocyanate and which develops an interparticle bond strength of at least 100 psi in unconfined compressive strength testing or prevents flowback in a flowback test.

25-26. (canceled)

27. A proppant comprising one or more of a hydrophobic coating, a coating that inhibits the formation of scale, a coating that reduces friction, a coating that controls sulfides, an acid or base resistant coating, a coating that inhibits corrosion, a biocidal coating, a coating that inhibits paraffin precipitation, a coating that inhibits asphaltene precipitation, a coating that comprises a tracer, an impact modifier coating, a coating for timed or staged release of an additive, a hydrate inhibitor coating, a hydrate anti-agglomerate coating, a clay stabilizer coating, or any combination thereof.

28. The proppant of claim 27, wherein:
the hydrophobic coating comprises a silane, chlorosilane, or fluorosilane;
the coating that inhibits the formation of scale is a polymeric coating that inhibits the formation of scale;
the coating that inhibits the formation of scale is a nonpolymeric coating that inhibits the formation of scale;
the coating that reduces friction comprises ethoxylated oleylamine; caprylic alcohol; C₆₋₁₂ ethoxylated alcohols; C₁₂₋₁₄ ethoxylated alcohols; C₁₂₋₁₆ ethoxylated alcohols; a superhydrophobic coating; a polybutadiene-containing polymer; a polyurethane with aliphatic segments; polymethylmethacrylate; a polydimethylsiloxane; or a non-ionic, water-soluble poly(ethylene) oxide polymer;
the coating that controls sulfides comprises at least one of a copper salt, zinc oxide, ferric oxide, a solid permanganate, a quinone, benzoquinone, a napthoquinone, an agent containing quinone functional groups, a polymer with pendant aldehyde groups, a dendrimer with terminal aldehyde groups, a dioxole monomer or polymer, an amine-terminated polymer, a metal carboxylate or chelate that forms an insoluble metal sulfate, a polyvinylferrocene, a polyferrocenylacrylates, or a nitrate salt;
the acid or base resistant coating comprises a polypropylene, an acrylic polymer, and a fluoropolymer other than fluoropolymers containing vinylidene fluoride;
the coating that inhibits corrosion comprises zinc particles; aluminum particles; 1-benzylquinolinium chloride; acetaldehyde; ammonium bisulfite; benzylideneacetaldehyde; castor oil; copper chloride; a fatty acid esters; formamide; octoxynol 9; potassium acetate; propargyl alcohol; propylene glycol butyl ether; 1-(phenylmethyl)-pyridinium; a tall oil fatty acid; a tar base; quaternized benzyl chloride; triethylphosphate; polyvinylpyridine; or polyvinylpyrrolidone;
the coating that inhibits paraffin precipitation comprises a styrene ester copolymer, a styrene ester terpolymer, a polyalkylated phenol, a fumerate-vinyl acetate copolymer, a copolymer of acrylic ester and allyl ether, urea, an unsaturated dicarboxylic acid imides with an ethylene-vinlyacetate backbone, a dicarboxylic acid amide, a dicarboxylic acid half amides, an ethylene-vinyl acetate copolymer, an acrylate polymers, or a maleic anhydride copolymer;
the coating that inhibits asphaltene precipitation is a polymer that comprises an alkylphenol/aldehyde resin; a polyolefin ester, amide, or imide with alkyl, alkylene phenyl, or alkylene pyridyl functional groups; an alkenylpyrolidone copolymer; a graft polymer of polyolefins with maleic anhydride or vinylimidazole; a hyperbranched polyesterimide; a lignosulfonate; or a polyalkoxylated asphaltene;
the proppant that comprises a hydrate inhibitor coating, a hydrate anti-agglomerate coating, or any combination thereof, comprise a layer of alkylated ammonium compound, an alkylated phosphonium compound, an alkylated sulfonium compound, or any combination thereof, and optionally a polymeric coating to encapsulate the layer that allows a timed or staged release of the alkylated ammonium compound, an alkylated phosphonium compound, an alkylated sulfonium compound, or any combination thereof; and
the clay stabilizer coating comprises a surfactant, an alkyl salt, a quaternary ammonium compound, a pyridinium salt, or any combination thereof.

29. (canceled)

30. The proppant of claim 28, wherein the polymeric coating comprises a phosphino-polycarboxylate, polyacrylate, polyvinylsulphonic acid, or sulphonated polyacrylate co-polymer.

31. (canceled)

32. The proppant of claim 28, wherein the nonpolymeric coating comprises fumaric acid; diethylene glycol; phosphorous acid; trisodium 2,2′-({2-[(carboxylatomethyl)amino]ethyl}imino)diacetate; sodium glycolate; glycine; trisodium nitrilotriacetate; 1,2-propylene glycol; methoxyacetic acid; methylphosphonic acid; polyphosphoric acids; alkylbenzene; phosphino-carboxylic acid; trisodium ortho phosphate; sodium polyacrylate; or diatomaceous earth.

33-46. (canceled)

47. The proppant of claim 27, wherein the proppant comprises a coating that comprises a tracer, an impact modifier coating, a coating for timed or staged release of an additive, or any combination thereof.

48. A resin-coated proppant that comprises a cured polyurethane coating associated with a polymeric treatment agent component, wherein the proppant comprises a core solid having a hard, glassy, cured, polyurethane coating over substantially the entire surface of the core solid, wherein the polyurethane coating has been made with a multifunctional polyether polyol and an excess of an isocyanate and which develops an interparticle bond strength of at least 100 psi in unconfined compressive strength testing, wherein the treatment agent component comprises one or more of: (a) a hydrophobic coating, (b) a coating that inhibits the formation of scale, (c) a coating that reduces friction, (d) a coating that comprises a tracer, (e) an impact modifier coating, (f) a coating for timed or staged release of an additive, (g) a coating that controls sulfides, (h) a polymeric coating other than a polymer formed from the first treatment agent, (i) an acid or base resistant coating, (j) a coating that inhibits corrosion, (k) a coating that increases proppant crush resistance, (l) a coating that inhibits paraffin precipitation, (m) a coating that inhibits asphaltene precipitation, (n) a coating comprising an ion exchange resin that removes anions and/or halogens, (o) a coating that inhibits hydrates, or prevents hydrate agglomerates from forming, (p) a coating that stabilizes clay, or any combination thereof.
